(19) United States
(12) Patent Application Publication
(10) Pub. No.: US 2011/0066454 A1
(43) Pub. Date: Mar. 17, 2011

(54) Risk Modeling System

(76) Inventors: Matt Rosauer, Denver, CO (US); Richard Vlasimsky, Denver, CO (US)

(21) Appl. No.: 12/950,633

(22) Filed: Nov. 19, 2010

Related U.S. Application Data
(63) Continuation of application No. 11/479,803, filed on Jul. 1, 2006, now abandoned.
(60) Provisional application No. 60/696,148, filed on Jul. 1, 2005.

(51) Int. Cl. G06Q 40/00

(52) U.S. Cl. 705/4

(57) ABSTRACT

A system including a general-purpose decision support and decision making predictive analytics engine that is able to find patterns in many types of digitally represented data. Given data that represents a random collection of points, the system finds these internal patterns employing an inductive principle called structural risk minimization that separates the points with the maximum margin. Internal patterns in the initial data are inductively determined by employing structural risk minimization to separate the points with a maximum margin. A model based on the internal patterns in the data is then generated, and the model is used with new data to generate predictions by evaluating the new data for similarities to the model. The model is implemented to facilitate decision making processes. Special features are provided to validate incoming data, preprocess the data, and monitor the data to improve the integrity of modeling results. Results are delivered to users by a reporting capability that facilitates the decision making processes that are inherent to a business enterprise.

### RELATED APPLICATIONS

This application is a continuation of application Ser. No. 11/479,803 filed Jul. 1, 2006 which claims benefit of priority to Provisional Application Ser. No. 60/696,148 filed Jul. 1, 2005. Both of the aforementioned applications are incorporated herein by reference.

### PROBLEM

Property and Casualty insurance carriers use manual actuarial techniques coupled with human underwriter expertise to price and segment insurance policies. Insurance carrier actuaries use univariate analysis techniques and underwriters draw from their own experience to price an insurance policy. By using existing actuarial and underwriting techniques, insurance carriers frequently under and over price risks creating retention risk and underwriting leakage risk.

Most insurance underwriters and insurance underwriting technologies consider risks univariately, analyzing individual risk factors one at a time. However, risk factors do not operate in isolation, instead, they interact. If viewed and analyzed in isolation, potentially significant alterations of combined risk factors may be unrecognized.

Building tens of thousands of sophisticated risk models using millions of data elements is computationally expensive. This process may require months of effort. Previously, building these models has required thousands of computing and person hours and the dedicated use of high-powered computers for long periods of time. The data models are typically built using a single workstation, thus limiting the speed of the building process to the power of the single machine. Use of multiple high powered workstations working in isolation does not solve this problem if the process is already pushing the envelope of any single machine's capabilities. What is needed a scalable solution that can be augmented as model complexity increases, which solution also reduces the long model building timeframe.

### SOLUTION

The present system overcomes the problems outlined above and advances the art by providing a general-purpose pattern recognition engine that is able to find patterns in many types of digitally represented data.

In one aspect, the present disclosure provides a modeling system that operates on an initial data collection which includes risk factors and outcomes. Data storage is provided for a plurality of risk factors and outcomes that are associated with the risk factors. A library of algorithms operate to test associations between the risk factors and results to confirm statistical validity of the associations. Optimization logic forms and tunes various ensembles by receiving groups of risk factors, associated data, and associated processing algorithms. As used herein, an “ensemble” is defined as a collection of data, algorithms, fitness functions, relationships, and/or rules that are assembled to form a model or a component of a model. The optimization logic iterates to form a plurality of such ensembles, test the ensembles for fitness, and select the best ensemble for use in a risk model.

Given data that represents a random collection of points, the system finds internal patterns by employing an inductive principle called structural risk minimization that separates the points with the maximum margin. In the case where the points are not separable, i.e., where there is noise in the data, the system makes trade-offs with these overlapping points to find the ‘center of gravity’ between them. In doing so, it develops a hypothetical contour map representing the structure or relatedness of the data.

In an exemplary embodiment, the present system may be built on a Java™ platform, and is architected on an open, XML-based API (applications programming interface). This API may, for example, be integrated with existing business systems, embedded into other applications, used as a web service, or employed to build new applications.

The system recognizes patterns in data and then assists development of a model by automated processing that is based on the data. The model may then be used with new data to make predictions by evaluating the new data for similarities to the model it developed.

In one embodiment, the system models chaotic, non-linear environments, such as those in the insurance industry, to more accurately represent risk and produce policy recommendations. For a particular insurance carrier, the system may build a company-specific risk model based upon the company's historical policy, claims, underwriting, and loss control data, and also may incorporate appropriate external data sources.

The system may utilize grid computing architecture with multiple processors on several machines which can be accessed across both internal and virtual private networks. This enables distribution of the model building effort from one processor to many processors and significantly reduces model building time.

To enable the grid computing architecture, a JavaSpace™ API is utilized. The overall architecture consists of one Java server, several workers, each running on a different machine, and one model building master, which coordinates the activities of the workers. The Java server is used to facilitate communication between the master and the workers. The goal of each model building cycle is to create one predictive candidate model. The master accomplishes this by creating thousands of permutations of risk factors and model parameters, and then submitting these parameters to the Java server. The workers retrieve one permutation of model parameters at a time, create a candidate model and evaluate the fitness of the resulting model. The result is then placed back into the Java server, where the master evaluates model fitness and submits a new set of model parameter permutations. This process is repeated until a high quality predictive candidate model is found.

The models that are built may be optimized based upon the carrier's financial objectives. For instance, a carrier may focus on reducing its loss ratio yet increasing its net profit. Multiple financial criteria are optimized simultaneously.

The present system includes built-in capacity control that balances the complexity of the solutions with the accuracy of the model developed. Optimizers are employed to reduce noise and optimize the accuracy of the model using common insurance industry metrics (e.g., loss ratio, net profit). In doing so, the present technology ensures that the model is neither over-fit nor under-fit. With a built-in ability to reduce the number of dimensions, the present platform condenses the risk factors (dimensions) being evaluated to the few that are truly predictive. A large number of parameters are thus not required to adjust the complexity of the model, thereby insulating the user from having to adjust a multitude of parameters to arrive at a suitable model. In the end, the models developed by the present system have less chance of introducing inconsistencies, ambiguities and redundancies, which, in turn, result in a higher predictive accuracy.

The present system explains its predictions by indicating which risk factor, or combination or risk factors, contributed to an underwriting recommendation. The system thereby delivers substantiating data that provides supporting material for state filings and for underwriters. Furthermore, it can search the risk model to determine if any changes in deductibles, limits, or endorsements would make the risk acceptable, allowing underwriters to work with an agent or applicant to minimize an insurer's exposure to risk.

In one embodiment, the system includes insurance-specific fitness functions that simulate the financial impact of using it objectively. By providing important insurance metrics that detail improvements in loss ratio, profitability, claim severity, and/or claim frequency, the present system provides an objective validation of the financial impact of a model before it is used in production. These fitness functions are integral to our optimization process, where we optimize models by running a simulation on unseen policies. The system further includes a fitness function to evaluate the underwriting application.

When analyzing insurance data from policy and claims administration systems, it is common to find insurance data that is empty or null. In most cases, this is a result of non-required fields, system upgrades, or the introduction of new applications. It is important to note that most data mining tools do not handle empty values well, thus requiring the implementer to assume average or median values when no values exist. This is a practical concern when implementing an underwriting model, as replacing empty values with other values biases the model, thereby decreasing the accuracy of the model developed. Most often, it renders potentially important risk factors unusable.

The present system handles null values gracefully. This increases the number of risk factors that can be practically evaluated, without employing misleading assumptions that would skew the predictive model. Furthermore, this ability becomes extremely useful for iterative underwriting processes, where bits and pieces of information are gathered over a period of time, thereby allowing an underwriter to obtain preliminary recommendations on incomplete information, and to further refine the recommendation as more information is gathered about an applicant.

Once a production risk model has been developed, it may be implemented for use in business operations, such as operations in such industries as insurance, finance, trucking, manufacturing, and telecommunications sectors, or any other industry that is in need of comprehensive risk management and decision making analysis. These industries may be subdivided into respective fields, such as for insurance: subrogation, collection of unpaid premiums, premium audit, loss prevention, and fraud. Users may interact with the system from a workstation on a real time basis to provide data as input and receive reports. System interaction may also be provided in batch mode by creating a data file that the system is able to process. The system may generate reports, such as images on a computer screen or printed reports to facilitate the target business operation. As implemented, the system provides a platform for managing risk in a particular business enterprise by facilitating decisions on the basis of reported predictive risk. Where the business enterprise may be engaged in a plurality of operations that entail distinct risks, these may be separately modeled. The respective models may be summed and used to predict the expected performance of the business enterprise as a whole.

### BRIEF DESCRIPTION OF THE DRAWINGS

FIG. 1 illustrates an exemplary methodology used in the present system for risk model development;

FIG. 2 is a graph showing a measurement of the accuracy or confidence of a model in predicting multivariate risk;

FIG. 3 provides additional information with respect to a component of optimizer logic also represented in FIG. 1;

FIG. 4 shows various design patterns that may be used by the optimizer logic to create ensembles for use in modeling;

FIG. 5 provides additional detail with respect to a booting pattern of FIG. 4;

FIG. 6 shows the use of fuzzy logic to provide the modeling system with deductive capabilities to assist the optimizer with learning recognition of data patterns for ensemble tuning;

FIG. 7 shows the use of statistical techniques for inductive logic to assist the optimizer with learning recognition of data patterns for ensemble tuning.

FIG. 8 shows by example an ensemble that is formed of computing components or parts that are respectively interconnected by data flow relationships;

FIG. 9 shows a process of blind validation constituting a final stage of model development;

FIG. 10 shows a blind validation result as the evaluation of loss ratio in deciles that are related to the suitability of policy terms and conditions for the perspective of an underwriter;

FIG. 11 provides another example of loss ratio calculation results bounded by a confidence interval that may be used for model validation;

FIG. 12 shows comparative results indicating the predictive enhancement that may be imposed by capping policy losses, as measured by predicted loss ratio;

FIG. 13 shows use of the bounded loss ratio results of FIG. 11 that may be inverted for use as a predictive model.

FIG. 14 shows the use of a plug-and-play ensemble for purposes of scoring risk by an underwriter;

FIG. 15 shows a grid architecture that may be used to enhance system capabilities in the management of workflow;

FIG. 16 shows a workflow pattern that used a web-based API to facilitate a master in the assignment of tasks to workers;

FIG. 17 shows a workflow pattern that is similar to that of FIG. 16, but accommodates multiple masters in the performance of multiple jobs to a shared workforce;

FIG. 18 shows a system for automated [predictive modeling;

FIG. 19 shows an account model setup for use in a modeling system; and

FIG. 20 shows a risk management platform or system that may be used to create and deploy risk modeling services;

FIG. 21 shows grouping of related logical components for one embodiment of the system;

FIG. 22 shows reporting of data and preprocessing of data for use by an ensemble;

FIGS. 23A and 23B graphically illustrate data monitoring on a comparative basis where the frequency distribution of incoming data is stationary (FIG. 23A) with respect to historical data that populates the system, and nonstationary (FIG. 23B);

FIG. 24 sows a scatterplot of actual losses versus a predictive risk assessment for particular policies that have been written;

FIG. 25 illustrates a graphical technique for model monitoring that may also be used for model validation on the basis of comparing actual losses to predictive risk scores, this chart showing that the model has relatively high predictive value;

FIG. 26 illustrates a graphical technique for model monitoring that may also be used for model validation on the basis of comparing actual losses to predictive risk scores, this chart showing that the model has relatively low predictive value;

FIG. 27 illustrates a graphical technique for model monitoring that may also be used for model validation on the basis of comparing actual losses to predictive risk scores, this case being that for an ideal model that is completely accurate; and

FIG. 28 is a graph that compares risked insurance policy pricing results that are improved by the system of this disclosure.

### DETAILED DESCRIPTION

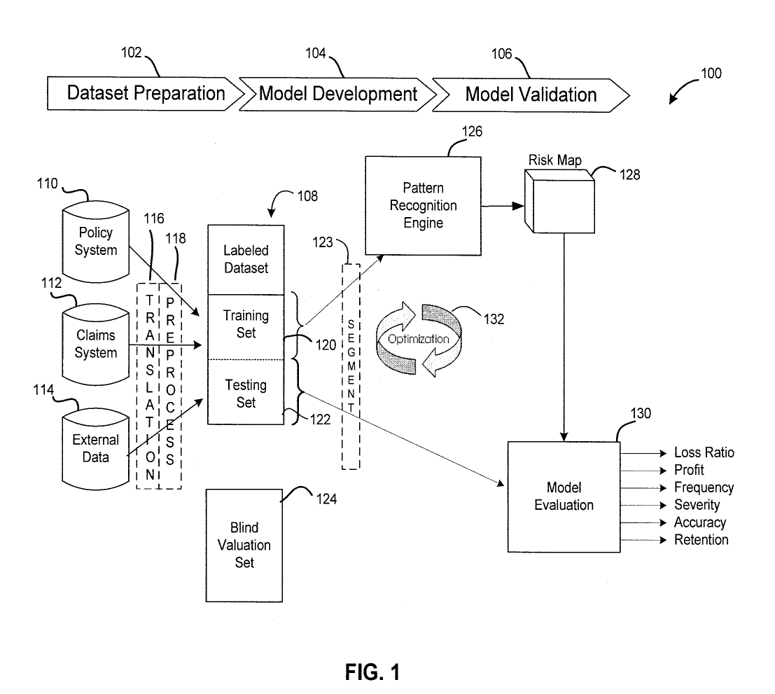

FIG. 1 illustrates an exemplary methodology 100 for use in the present system. The methodology is particularly useful for model development, testing and validation according to the instrumentalities disclosed herein. The methodology 100 may be used to build models for use in a overall system that may be used, for example, by insurance underwriters and insurance agents or brokers.

As shown in FIG. 1, three basic steps are involved in finding patterns from digitally represented data, and generating a model based on the data. As shown in FIG. 1, these steps include data set preparation 102, together with an iterative process of model development 104 and validation 106. In this iterative process, a candidate model is created based upon reporting from a dataset, and the fitness of the resulting model is evaluated. The result is then reevaluated to confirm model fitness. This process is repeated, using a new set of model parameter permutations until a predictive candidate model is found.

Although the general methodology may be used to make any risk assessment, particular utility is found in the insurance industry. The predictive model may be used to answer any question that is relevant to the business of insurance. Generally, this information includes at least a projection of the number of claims, the size of claims, and the chance of future loss that may be expected when underwriting an insurance policy. Knowledge of this information may permit an underwriter, for example, to change policy terms for mitigation of risk exposure. This may include revising the policy to limit or eliminate coverage for specified events, to change the policy fee structure depending upon the combined risk of loss for a grouped risk profile, and/or to adjust policy length or term. The predictive model is used, in general terms, to assure that total losses for a given policy type should be less than the total premiums that are paid.

### Data Set Preparation

The first step to preparing a predictive model is to assemble the available data and place it in storage for reporting access. The dataset preparation 102 may combine tasks that require manual intervention with, for example, rules-based processing to derive additional calculated data fields and improve data integrity. The rules-based processing may assure, for example, that a database is populated with data to assure accuracy up to some delimiting value, such as 80% integrity. Rules-based processing may be provided to reduce the amount of manual intervention that is required on the basis of experience in converting the data for respective policy types. Generally, this entails translating data that is stored in one format for storage in a different format, together with preprocessing of the data to derive further data also characterizing the resultant dataset.

### Internal Data

The available data from an insurance carrier is clearly defined and analyzed in the step of dataset preparation 102, which provides the initial phase of a modeling project in accordance with the present system. The purpose of dataset preparation 102 is to provide the dataset 108. The dataset 108 contains data elements that are sufficiently populated and reliable for use in analysis. The dataset 108 contains at least internal data that is provided from the carrier, such as policy data 110 and claims data 112. Together, the policy data 110 and claims data 112 represent internal data sources that are on-hand and readily available from the systems of an insurance company or policy underwriter.

The policy data 110 includes data that is specific to any policy type, such as automobile, health, life worker's compensation, malpractice, home, general liability, intellectual property, or disability policies. The policy data 110 contains information including, for example, the number of persons or employees who are covered by the policy, the identify of such persons, the addresses of such persons, coverage limits, exclusions, limitations, payment schedules, payment tracking, geographic scope, policy type, prior risk assessments, historical changes to coverage, and any other policy data that is conventionally maintained by an insurance company.

The claims data 112 contains, for example, information about the number of claims on a given policy, past claims that an insured may have made regardless of present coverage, size of claims, whether clams have resulted in litigation, magnitude of claims-based risk exposure, identity of persons whose actions are ultimately responsible for causing a claim to occur, timing of claims, and any other data that is routinely tracked by an insurance company.

### External Data

External data 114 generally constitutes third party information that is optionally but preferably leveraged to augment the dataset 108 and prepare for the modeling process. A number of external sources are available and may be accessed for reporting purposes to accept and integrate external data for modeling purposes that extend modeling parameters beyond what underwriters currently use today. The external data may be used to enrich data that is otherwise available to achieve a greater predictive accuracy. Data such as this may include, for example, firmagraphic, demographic, demographic, econometric, geographic, weather, legal, vehicle, industry, driver, property, and geo-location data. By way of example, external data from the following sources may be utilized:
Experian® (a registered trademark of Experian Information Solutions, Inc. operating from Costa Mesa, Calif. as applied to a computer database in the fields of commercial and consumer credit reporting);
Bureau of Labor Statistics, such as Local Area Unemployment Statistics;
U.S. Census, such as Population Density, and housing density; and
Weather information, such as snow, rain, hail, wind, tornado, hurricane, and other severe weather statistics reported by counties, states or airports;
Public records that are published by government agencies, public interest groups, or companies;
Subscription membership databases including industrial data, financial data, or other useful information;
Data characterizing an industry, such as NAIC or SIC codes;
Law enforcement data indicating criminal acts by individuals or reporting statistics representing incidence of crime in a given geographic area;
Wage data reported by county or state
Attorney census data;
Insurance law data and/or;
Geopolitical or demographic data.

The policy data 110, claims data 112, and external data 114 are converted from the systems by the use of translation logic 116. Such data is reported from the storage data structure or format where it resides and converted for storage in a new structure in the form of dataset 108. In one example of this, the data may be reported from a plurality of relational databases and stored in the new format or structure of a relational database in the form of dataset 108. The datsaset 108 is stored in a predetermined structure to facilitate downstream modeling and reporting operations for steps of model development 104 and model validation 106.

### Derived Data and Preprocessing

Although many data fields may be translated for direct storage in the dataset 108, some fields may benefit by transforming the data by use of preprocessing logic 118. For example, the number of units on a policy can often be used in its raw data form, and so may not require preprocessing. Dates of birth, however, may be converted into policyholder age data for use in a model. The preprocessing logic 118 may in this instance consider when the data was collected, the data conversion date, the format of the data, and handling of blank fields. In one example of this, when converting policy data 110, blank fields may be stored as a null, or it may be possible to access external data 114 to provide age data.

In one aspect, the preprocessing logic 118 may provide derived data elements by use of transformations of time, distance and geographic measures. In one example of derived data elements, postal zip codes may be used to approximate the distance that a professional driver must travel to and from work. An algorithm may compute this, for example, by assigning points of latitude and longitude each at an address or center of a zip code area, and calculating the distance between the two points. The resultant derived data element may improve risk assessment in the eventual modeling process, which may associate an increased risk of accidents for drivers who live too far from work. These drivers are burdened with an excessive commute time, and it is at least possible that they may cause excessive on the job accidents as a result of fatigue. In another example, zip codes may be used to assess population density by association with external demographic statistics. Certain policy types may encounter increased or decreased chances of risk due to the number of people who work or reside in a given area. Another example in the use of zip codes includes relating a geographic location to external weather information, such as average weather conditions or seasonal hail or other storm conditions that may also be used as predictive loss indicators. Other uses of derived data may include using demographic studies to assess likely incidence of disease or substance abuse on the basis of derived age and geographical location.

The additional derived data increases the number of risk factors available to the model, which allows for more robust predictions. Besides deriving new risk factors, pre-processing also prepares the data so modeling is performed at the appropriate level of information. For example, during preprocessing, actual losses are especially noted so that a model only uses loss information from prior terms. Accordingly, it is possible to adjust the predictive model on the basis of time-sequencing to see, for example, if a recent loss history indicates that it would be unwise to renew an existing policy under its present terms.

The dataset 108 may be segmented into respective units that include a training set 120, a test set 122, and blind validation set 124.

The training set 120 is a subset of dataset 108 that is used to develop the predictive model. During the “training” process, and during the course of model development 104, the training set 120 is presented to a library of algorithms that are shown generally as pattern recognition engine 126. The pattern recognition engine performs multivariate, non-linear analysis to ‘fit’ a model to the training set 120. The algorithms in this library may be any statistical algorithm that relates one or more variables to one or more other variables and tests the data to ascertain whether there is a statistically significant association between variables. In other words, the algorithm(s) operate to test the statistical validity of the association between the risk factors and the associated outcomes.

Multivariate models should be of a complexity that is just right. Models that incorporate too little complexity are said to under-fit the available data and result in poor predictive accuracy. On the other hand, models that incorporate too much complexity can over-fit to the data that is used. This causes the model to interpret noise as signal, which produces a less accurate predictive model. A principle that is popularly known as Occam's Razor holds that one may arrive at an optimum level of complexity that is associated with the highest predictive accuracy by eliminating concepts, variables or constructs that are not needed to explain or predict a phenomenon. Limiting the risk factors to a predetermined number, such as ten per coverage model, allows utilization of the most predictive independent variables, but is also general enough to fit a larger range of potential policies in the future. A smaller set of risk factors advantageously minimizes disruptions to the eventual underwriting process, reduces data entry and simplifies explainability. Moreover, by selecting a subset of risk factors having the highest statistical correlation, and thus the highest predictive information, provides the most desirable target model.

Before data from the training set 120 or testing set 122 are submitted for further use, it is possible to use a segmentation filter 123 to focus the model upon a particular population or subpopulation of data. Thus, it is possible to report form the labeled dataset 108 to provide data for modeling input that is filtered or limited according to a particular query. In one example of this, a model for automotive driver's insurance may be developed on the basis of persons who have been convicted of zero traffic violations, where the incidence of traffic violations is known to be a conventional predictive risk factor. Separate models may be developed for those who have two, three, or four traffic convictions in the last five years. These subpopulations of dataset 108 may be further limited. to types of violations, such as speeding or running a red light, and as particular geography, such as a residence in a particular state or city. According to this strategy, a target variable is reported on the basis of a parameter that operates as a filter. The target data may be reported into additive components, such as physical damage of loss and assessment of liability, for example, where a driver may have had an accident that caused a particularly large loss, but the driver was not at fault. The target data may also be reported in multiplicative combinations, such as frequency of loss and severity of loss. Segmentation may occur in an automated way based upon an empirical splitting function, such as a function that segments data on the basis of prior claims history, prior criminal history, geography, demographics, industry type, insurance type, policy size as measured by a number of covered individuals, policy size as measured by total amount of insurance, and combinations of these parameters.

Accordingly, the pattern recognition engine 126 uses statistical correlations to identify data parameters or fields that constitute risk factors from the training set 120. The data fields may be analyzed singly or in different combinations for this purpose. The use of multivariate of ANOVA analysis is particularly advantageous for this purpose. The pattern recognition engine 126 selects and combines statistically significant data fields by performing statistical analysis, such as a multivariate statistical analysis, relating these data fields to a risk value under study. Generally, the multivariate analysis combines the respective data fields using a statistical processing technique to stratify a relative risk score and relate the risk score to a risk value under study.

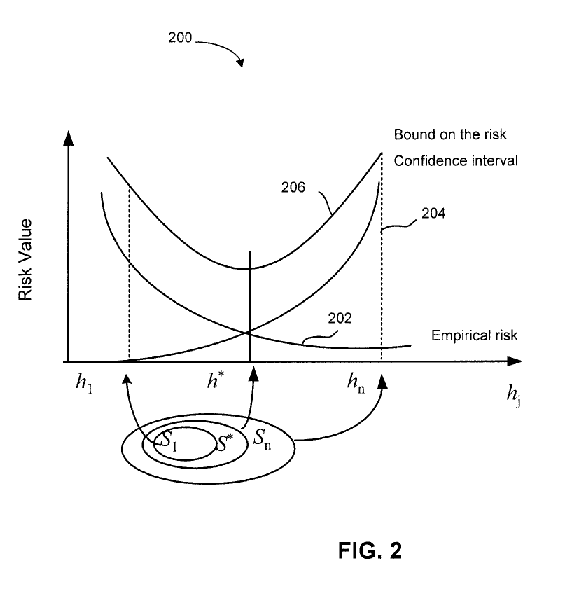

FIG. 2 illustrates the calculation results from pattern recognition engine 126 as a risk map 200. Statistically significant data fields from the training set 120 include n such fields S₁, S₂, S₃ . . . Sₙ. including a mean value S*. ANOVA may be used to relate or combine these fields and stratify a relative risk score h₁, h₂, h₃ . . . hj in a range of j such values as the ordinate of a histogram. The abscissa quantifies the category of risk value under study, such as loss ratio, profit, frequency of claims, severity of risk, policy retention, and accuracy of prediction. An empirical risk curve 202 relates this structure to data from the training set 120. A statistical confidence interval 204 places bounds on the risk according to a statistical confidence interval calculation, such as a standard deviation or 95% confidence. The bound on the risk 206 is the sum of empirical risk and the confidence interval.

More generally, the calculation results shown in FIG. 2 are merely one example. A variety of multivariate statistical processing algorithms are known in the art. The pattern recognition engine 126 produces a number of such maps to quantify a risk parameter or category with particular risk category. Different risk variable groups may be used to quantify or map the risk for any particular model. The risk maps are useful in forming ensembles, according to the discussion below. The ensembles may be submitted for use by risk mapping logic 128 for further processing in accord with what is discussed below.

Output from the pattern recognition engine 126 is provided to risk mapping logic 128 for model development Risk mapping logic 128 receives output from the pattern recognition engine 126, selects the most statistically significant fields for combination in to risk variable groups, builds relationships between the risk variable groups to form one or more ensembles, and analyzes the ensembles by quantifying the variables and relationships in association with a risk parameter.

In one aspect, while building models by use of the risk mapping logic 128, the risk factor with the most predictive information may be first selected. The model then selects and adds the risk factors that complement the existing risk factors with the most unique predictive information. To determine the most predictive model, results from the model are analyzed to determine which model has the highest predictive accuracy across the entire book of business. Such risk factors may be continuously added until the model is over-fit and predictive accuracy begins to decline due to over complexity. Many problems cannot be solved optimally in a finite amount of time. In these cases, seeking a good solution is often a wiser course of action than seeking an exact solution. This type of ‘good’ solution may be defined as the best candidate model from among a large number of candidate models under study. In accordance with at least one embodiment, the modeling process is not a linear process, but rather is an iterative on seeking an optimal solution, e.g.

Model->analyze->refine->model->etc.

The output from risk map logic 128 includes a group of statistically significant variables that are related by association to form one or more ensembles that may be applied for use in a model. These results are transferred to model evaluation logic 130. The model evaluation logic 130 uses data from the test set 122 to validate the model as a predictive model. The test may be used, for example, to evaluate loss ratio, profit, frequency of claims, severity of risk, policy retention, and accuracy of prediction. The test set 122 is a separate portion of dataset 108 that is used to test the risk mapping results or ensemble. Values from the test set 122 are submitted to the model evaluation logic to test the predictive accuracy of a particular ensemble.

Using massively parallel search techniques, optimization logic 132 develops a large number of such models, such as thousands or tens of thousands of models, that are blindly tested using data from the test set 122 to predict risk outcomes. These predictions are made without the current term loss amounts, which are used only in evaluating the policy model's predictive accuracy. Thus, the model makes predictions blindly. The model may then be evaluated by comparison to actual current term loss results in the test set 122.

The blind validation set 124 is used in model validation 106 for final testing once the optimization process is complete. This data is used only at the completion of a model optimization process to ensure the most objective test possible. The reason for providing a blind validation set 124 is that the test set 122 which is used in optimizing the model is not wholly appropriate for a final assessment of accuracy. The blind validation set 124 is a statistically representative portion of data for the total policy count. The data are set aside from the model building process to create a completely blind test set. Like the test set 122, the predictions for the blind validation set are made without the current term loss amounts. The current loss amounts are used only in evaluating the model's predictive accuracy.

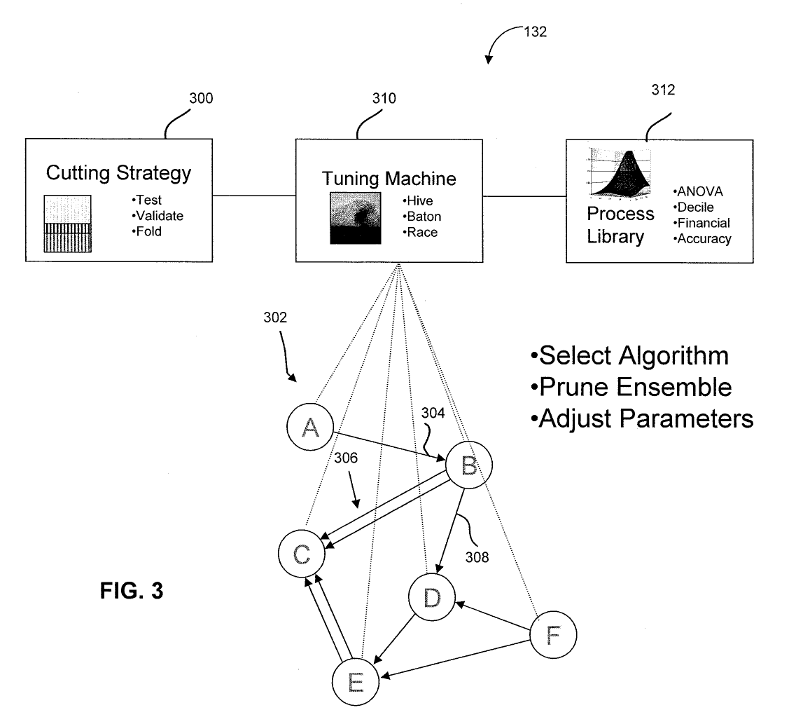

FIG. 3 provides additional detail with respect to the optimization logic 132. A cutting strategy component 300 selects fields from the output of risk mapping logic 128 for use in an ensemble 302. The ensemble 302 may be a directed acyclic multigraph. The cutting component 300 samples and tests data from the training set 120 to build initial associations or relationships among the respective fields or variables therein. An ensemble 302 is created by associating selected parts A, B, C, D, E and F. These parts A-F represent a combination of ensemble components, each as a stage of processing that occurs on one or more numbers, text or images. This processing may entail, for example, preprocessing to validate or clean input data, preprocessing to provide derived data as discussed above, risk mapping of the incoming data, statistical fitness processing of the incoming data or processing results, and/or the application of an expert system of rules. Information flow is shown as an association between the respective elements A-F. As shown, part A has an association 304 with variable B which, in turn, passes information to part C according to association 306. Part B provides information to part D according to association 308. Part F provides information to parts D and E. The flow of information is not necessarily sequential, as shown where part E passes information to part C. The relationships are tested, validated and folded to ascertain their relative significance as a predictive tool. The fields A, B, C, D, E and F are selected from among the most statistically significant fields that have been identified by the pattern recognition engine 126 (not shown).

The cutting strategy component provides output to a tuning machine 310. which may draw upon a process library 312 for algorithms that may be used for processing at each of parts A-F. The associations 304, 306, 308 are adjusted to provide for the flow of information, as needed for use by these algorithms. The process library may, for example, contain ANOVA algorithms used to study the data and to check the accuracy of statistical output. Analysis may be done, for example, on a decile basis to study financial data. The tuning machine generates a very large number of ensembles by selecting the best algorithm from the process library 312, pruning the ensemble by eliminating some data fields and adding others, and adjusting the input parameters for the respective algorithms. The fine-tuning process may include adjusting the number of variables by adding or deleting fields or variables from the analysis, or adjusting relationships between the various components of an ensemble.

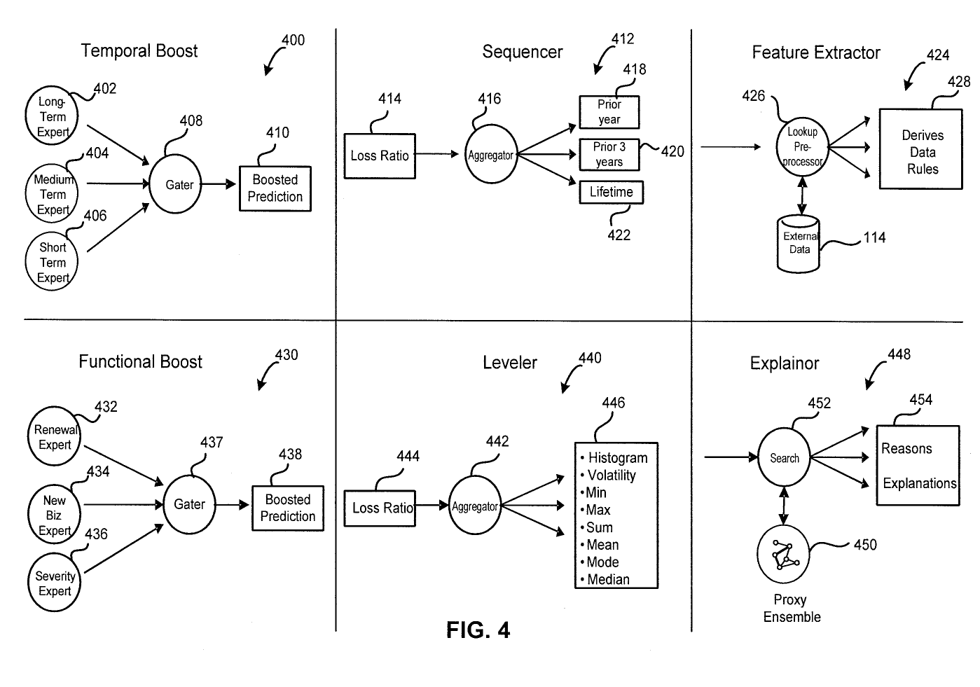

FIG. 4 provides additional detail with respect to the creation of ensembles by the use of process library 312. In one aspect, the process library 312 may be provided as an expert system that contains rules for analysis of the data. Experts in these fields and experts in the field of model building may be consulted to provide options for ensemble building, and these options may be provided as a system of expert rules. This is particularly useful in the development of relationships or associations among the various parts of the ensemble. Pattern 400 constitutes a temporal boost. In this case, industry experts are consulted to identify underwriting parameters that foment rules 402, 404, 406 constituting predetermined parameters to boost long, short, and medium term policy financial results. In one example of this, policy premiums may be adjusted to bring more people into or out of coverage under a particular policy. This changes the risk basis and economic picture of the overall policy by adjusting the number of insured people. The policy financial results may be altered depending upon the demographics of the people who self-select for coverage. A gater 408 compares these results and may mix results from various rules to achieve a boosted prediction 410 on the basis of changed coverage.

In another instance, pattern 412 addresses a sequencer analysis. Historical risk values, such as those for loss ratio field 414, may be time-segregated to ascertain the relative predictive value of the most current information versus older data. The sequencer provides a temporal abstract that may shift a variable over time. This feature may be used to search for lagging variables in a dataset, such as prior claim history. An aggregator 416 may consider the time-segregated data in respective groups to see if there is a benefit in using segregated data for different time intervals, such as data for the prior year 418, prior three years 420, or policy lifetime 422. The aggregator 416 operates upon prior history to roll up or accumulate extracted values over a predetermined time interval.

Pattern 424 is a feature extractor that contains a lookup pre-processor 426. The lookup pre-processor 426 accesses external data 114 to provide or report from derived data 428, which has been obtained as described above. This data receives special handling to form ensembles in an expert way according to a predetermined set of derived data rules 428. The lookup pre-processor 426 may utilize a variety of numeric, nominal or ordinal techniques as statistical preprocessors. These may operate on values including SIC codes, NCCI codes, zip codes, county codes, country codes, state codes, injury statistics, health cost statistics, unemployment information, and latitude and longitude. These may be applied using expert rules to convert such codes or values into statistically useful information.

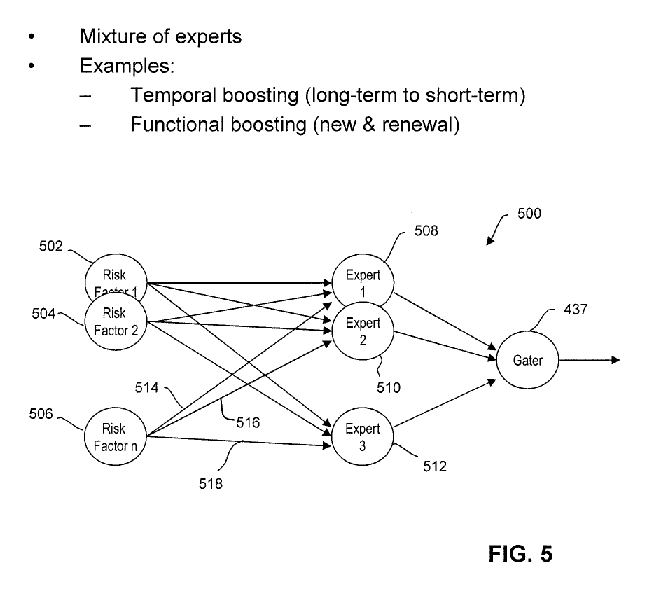

Pattern 430 provides a functional boost by use of rules that have been established by a policy renewal expert 432, a new business expert 434, and a severity of loss expert 436. A gater 437 uses these rules to provide a boosted prediction 438, which may be provided by selectively combining rules from different expert datasets, such that a particular combination may contain subsets of rules from the policy renewal expert 432, the new business expert 434, and/or the severity of loss expert 436. As shown in FIG. 5, an ensemble 500 may be created by in-parallel assignment of a plurality of risk factors 502, 504, 506 to respective sets of expert rules 508, 510, 512, which may be for example those for the policy renewal expert 432, new business expert 434, and severity of loss expert 436.

Pattern 440 is a leveler protocol that places boundaries on the risk information to avoid either undue reliance on a particular indicator or excess exposure in the case of high damages exposure. The connections may be made on a many-to-one basis as exemplified by connections 514, 516, or a one-to-one basis as shown by connection 518. Thus, expert rules 512 may operate on risk factors 502, 504, 506 or and combination of risk factors. The gater 437 processes the combined output form expert rules 508, 510, 512 to select the best options for implementation in the ensemble. An aggregator 442 applies special rules operating on a particular risk parameter, such a s loss ratio 444, on the basis of statistical results including a risk histogram, volatility, minima, maxima, summation of risk exposure, mean, mode, and median. The rules consider these values in an expert way to control; risk and avoid undue reliance on too few indicators. The aggregator 416 operates upon prior history to roll up or accumulate extracted values over a predetermined time interval.

Pattern 448 provides an explainer function. The multivariate statistical analysis results are advantageously more accurate, but disadvantageously more difficult to explain. These issues both pertain to the way in which the analysis relates multiple variables to one another in a complex way. Accordingly, each proxy ensemble 450 is submitted for testing by a search agent 452. The search agent 452 identifies the data fields that are used in the model then quantifies the premium cost, limitations, and/or exclusions by way of explanation according to the associations that are built into the ensemble. Accordingly, the output from search agent 452 provides simplified reasons and explanations 454 according to this analysis.

Accordingly, a wide variety of rules-based model building strategies may be implemented. The respective ensembles may be provided to mix or combine the respective rules-based output. As described above, each ensemble is tested on an iterative basis, and the ensemble my grow or rearrange with successive iterations. In a very large number of calculations, the optimization logic 130 may select at random different sets of rules for recombination as an ensemble. The model evaluation logic may test these ensembles to ascertain the predictive value. When a sufficient number of such tests have been run, such as thousands of such tests, it is possible to use logical training processes to weight or emphasize the variables and algorithms that in combination yield the highest predictive value.

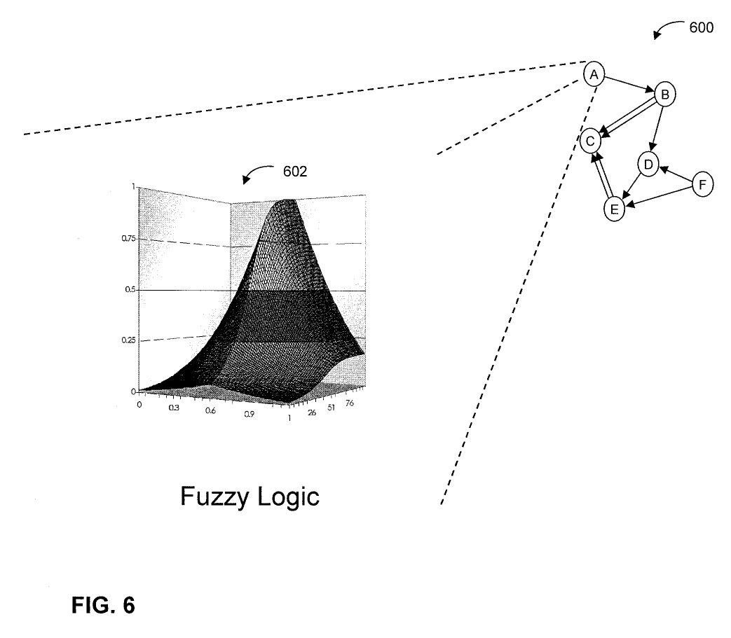

In one aspect of this, FIG. 6 shows the use of deductive logic where a particular ensemble 600 is analyzed to provide a three dimensional map 602 comparing actual loss results to predictive loss results. The optimization logic 130 then selects the data parameters and the algorithms that yield the best confidence intervals. These may be weighted for further modeling purposes to use such data parameters and algorithms in combination at a relatively high frequency, i.e., at a frequency greater than a random process selecting form these data parameters and algorithms.

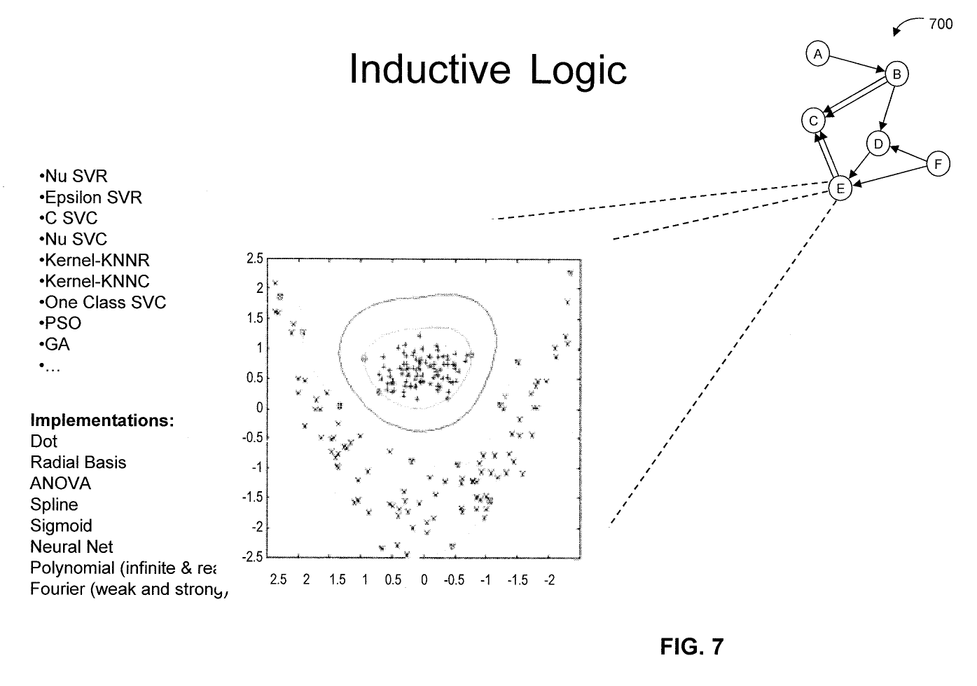

Another type of logic that may be used for this purpose is inductive logic as shown in FIG. 7. Algorithms that are provided as natural intelligent learning algorithms may be used to train themselves from the raw data of dataset 108, or by use of interim calculation results. Each component of the ensemble 700 may be reviewed for predictive value using generally, for example, kernel or other mathematical techniques as dot, radial basis, ANOVA, Spline, Sigmoid, Neural Networking, polynomial (infinite and real), and Fourier processing (weak and strong). The resulting model may implement techniques including Nu SVR, Epsilon SVR, SVC, Nu SVC, Kernel-KKNR, Kernel KNNC, One class SVC, PSIO, and GA Algorithmic techniques that are not particularly strong may be discarded in favor of substitutes.

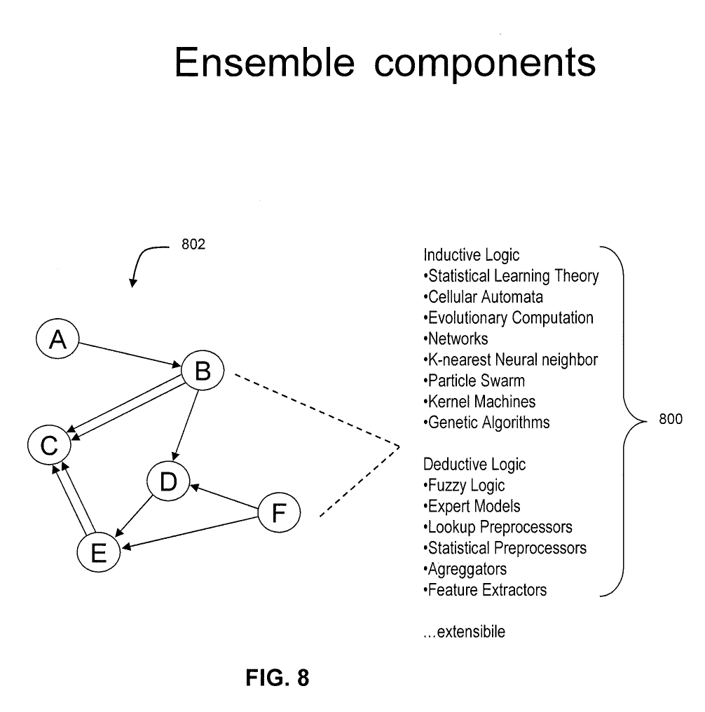

FIG. 8 provides a listing of inductive logic and deductive logic features that may be used in the respective ensemble components.

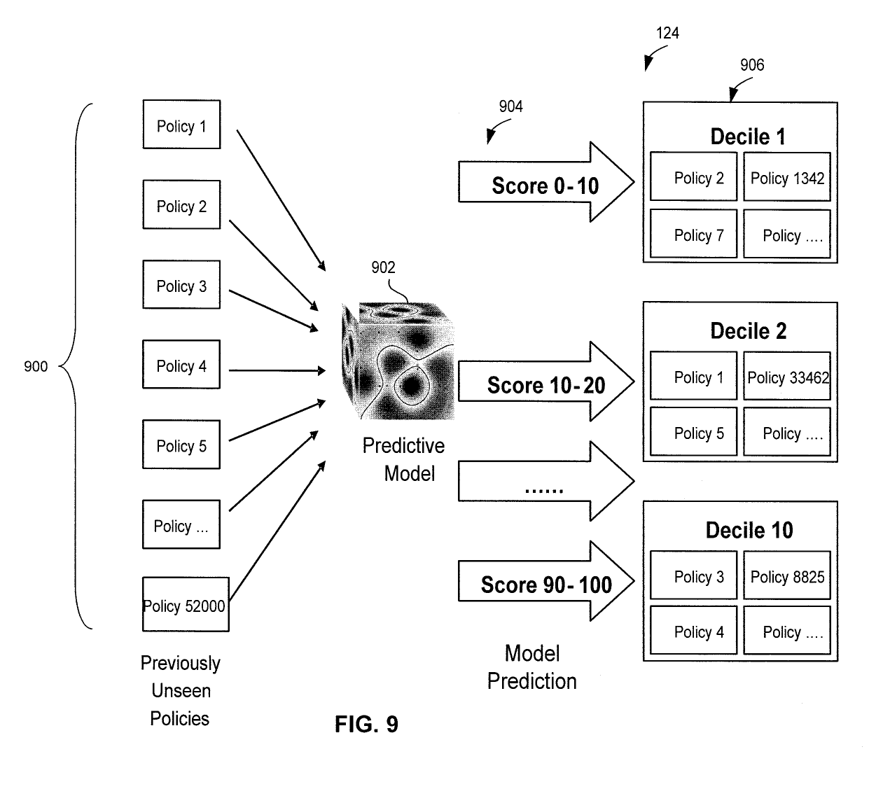

As shown in FIG. 9, the blind validation logic 124 proceeds once the step of model development 104 is complete. The terms and conditions of each policy that is contemplated for issuance are provided as input and submitted for modeling through one or more ensembles that are selected from the model development process 104. additional terms and conditions may be generated, for example, through the use of a rules-based system or by manual input. This provides information representing policies 900 for analysis, which may include current policies, past policies, and previously unseen policies. The respective policies are submitted to the one or more ensembles, each of which is used as a predictive model 902. The predictive model 902 generates predicted outcomes on the basis of risk modeling according to a particular ensemble using as input data from the blind data set 124. These may be stratified as a histogram, for example, by scoring relative risk according to decile 904. An allocation routine 906 may allocate selected policies to the deciles where they achieve the best financial result according to fitness of the model for a particular category of risk.

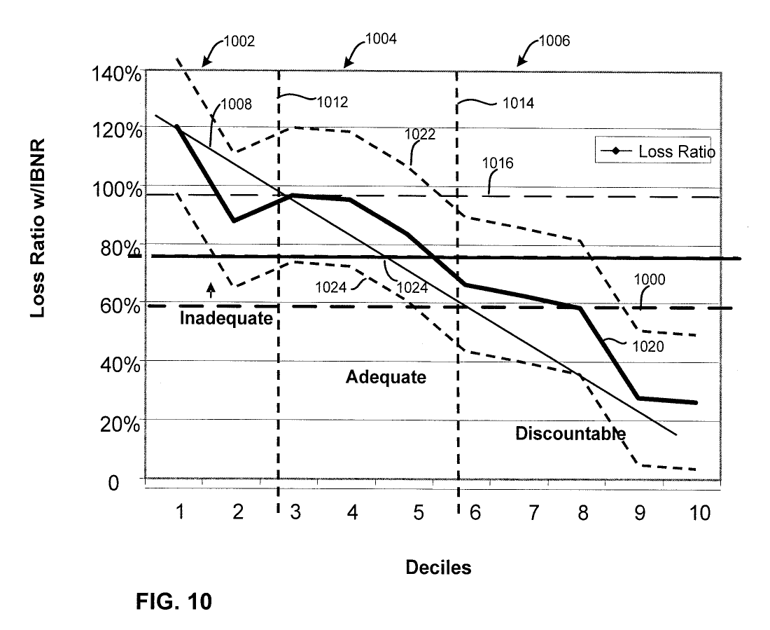

This type of policy allocation may be provided as shown in FIG. 10 for a particular policy that is measured by loss ratio. A delimiting value 1000 may be arbitrarily set according to customary standards for profitability according to a particular insurance type. Sector 1002 shows predicted policy results that are inadequate to the level of risk. This is shown where the loss ratio exceeds the delimiting value 1000. A trend line 1008 may define a sector of adequate policy terms and conditions in sector 1004, whereas the policy terms and conditions in sector 806 are discountable because the predicted loss ratio is too low. The trend line 1008 defines the adequate sector 1004 where the trend line 1008 crosses the delimiting value 1000 at point 1010. Boundaries 1012 and 1014 constitute, respectively, the maximum and minimum levels of risk decile that are generally regarded as being acceptable for a particular policy. These may be determined as the intercepts between trend line 1010 and the respective maximum and minimum acceptable loss ratios 1016, 1018. It will be appreciated that what is shown in FIG. 10 is only one way to evaluate the suitability of a given policy according to predicted loss ratio curve 1020 and that alternative evaluation methods may be utilized in other embodiments. The loss ratio curve 1020 may be bounded by a confidence interval 1022, 1024.

In another aspect, as shown in FIG. 12, it will be appreciated that the terms and conditions for a particular policy may be adjusted to accommodate irregularities in the predictive model results. The loss ratio results of FIG. 12 show an anomalous upward bulge for the medium risk segment of business. This may be smoothed upon policy renewal or the writing of new policies, for example, by capping the amount of a particular loss category. The predicted capped data is shown as curve 1202, which is substantially smoothed in the area of bulge 1200. Reconnaissance of what limits to cap may be gained by the explainer functionality 448, as shown in FIG. 4. Thus, by comparing capped to uncapped losses, or the adjustment of any policy condition that is nominated for change, the overall system may compare these options to produce a better underwriting result.

The following examples show a practical implementation of the foregoing principles. They teach by way of example, not by limitation.

### Example 1

### Dataset Preparation

Data from a commercial auto and driver insurer was obtained for the present examples representing five years of archive policy data for policies with effective dates between Jan. 1, 1999 and Jan. 1, 2003. Once the dataset was prepared with all of the internal, external and derived data elements, it was segmented into three subsets including a training set, a test set, and a blind validation set.

For the presently-described project, the training and testing datasets were taken as a randomized sampling to include 66% of the first 4 years of data. The blind validation dataset was taken from the remaining random 33% of the first 4 years of data and the entire 5^{th} year of data. Holding back the entire 5^{th} year of data for the blind validation dataset yields performance measures that are most relevant to production conditions because the data predicted is from the most recent time period which was not available during model training. This is useful due to ever-changing vehicle and driver characteristics in the commercial auto insurance business. Below are the aggregate written premium and policy term counts used during this project:

TABLE I
Summary of Model Data Set Characteristics

| Dataset | Written Premium | Policy/Term Count |
|---|---|---|
| Training/Test set | $120,607,477 | 9,008 |
| Blind Validation set | $56,468,680 | 6,163 |
| Total Dataset Used in POC | $177,076,157 | 15,171 |

### Example 2

### Model Development and Validation

The modeling process evaluated data elements at the vehicle coverage level. Modeling is best done at the lowest level of detail available for a unit at risk, which is a vehicle in this case. For this reason, a total of 18 different policy coverages were segmented into the two main coverage types, namely, liability and physical damage. Several modeling techniques from a library of statistical algorithms were then evaluated on an iterative basis to build the most predictive model for each coverage type.

### Risk Factor Analysis

From the technique described above, the model chooses the ten risk factors for each coverage model that added the most predictive information to create the target model.

### Other Risk Factors Considered

Before arriving at the target model, additional risk factors were considered using other models. Specifically, several candidate models evaluated datasets with prior year loss information, such as claim counts and losses evaluated over prior years. Interestingly, prior loss information only appeared as a predictive risk factor in about 20% of the candidate models. Statistical analysis shows that prior loss information experiences a survivorship bias. A survivorship bias occurs over time when a sample set becomes more homogenous as only preferred data survives from term to term. Homogenous data does not add predictive information because there is little variance. This does not mean that prior loss information is not valuable to underwriting, only that once a strict underwriting rule is in place, it is not as valuable as a risk factor. In one example, a graph may be created to display the predictive value of a prior loss data element (claim count).

TABLE II
Risk factors in the Liability and Physical Damage Models Using Various
Data Sources

| Ranking | | Data Level | Source |
|---|---|---|---|
| | Liability Model with Experian | | |
| 1 | Population density per sq mile based on Zip | Vehicle | External |
| 2 | Age of Vehicle in Years | Vehicle | Internal |
| 3 | Percentile of Experian Score | Policy | Experian |
| 4 | Housing density per sq mile based on Zip | Vehicle | External |
| 5 | Manual Premium of Vehicle Coverage | Vehicle Coverage | Internal |
| 6 | Vehicle Year | Vehicle | Internal |
| 7 | Rural or Urban | Vehicle | Internal |
| 8 | Number of Years on File | Policy | Experian |
| 9 | Score Factor 2 | Policy | Experian |
| 10 | Number of Original Vehicles on Policy | Policy | Internal |
| | Physical Damage Model with Experian | | |
| 1 | Seating Capacity of Vehicle | Vehicle | Internal |
| 2 | Population density per sq mile based on Zip | Vehicle | External |
| 3 | Manual Premium of Vehicle Coverage | Vehicle Coverage | Internal |
| 4 | Population density per sq mile based on County | Vehicle | External |
| 5 | Number of Original Vehicles on Policy | Policy | Internal |
| 6 | Number of Drivers | Policy | Internal |
| 7 | Driver to Vehicle ratio | Policy | Internal |
| 8 | Percent of Agency Business with Lancer | Policy | Internal |
| 9 | Score Factor 1 | Policy | Experian |
| 10 | Vehicle Class Size | Vehicle | Internal |

Comparison of Risk Factors that Appear Similar

In the presently described modeling process, two risk factors that are highly correlated may provide essentially the same information, so both risk factors would not be included in a model even if they are independently predictive. A specific example is that of seating capacity and body type in the physical damage model. Independently, seating capacity and body type were the two most informative risk elements. However, the model excluded body type because it did not add unique predictive information.

Conversely, there are risk factors that seem to be highly correlated, but do in fact provide unique predictive information. Specifically, two different risk factors exist in the Physical Damage model measuring population density, one based on zip code, the other base on county.

III: Percentage of Accidents as a Function of Distance

| | |
|---|---|
| Miles from home | Percentage of accidents |

| | | |
|---|---|---|
| 1 | mile or less | 23 percent |
| 2 to 5 | miles | 29 percent |
| 6 to 10 | miles | 17 percent |
| 11 to 15 | miles | 8 percent |
| 16 to 20 | miles | 6 percent |
| More than 20 | miles | 17 percent |

Additionally:
Accidents were more than twice as likely to take place one mile from home compared to 20 miles from home.
Only 1 percent of reported accidents took place fifty miles or more from home.

Since almost a quarter of accidents happen within one mile of home, understanding the population density of a zip code is very valuable to understanding the substantial risk near the garage location. Knowing the county population density further enhances the risk predictions as it captures the larger travel radius for each vehicle. Either risk factor is beneficial to a model, but due to the importance of these estimates, both risk factors appear in the target model. Statistically, there is a difference between these two population densities in the model. From policies in the blind validation dataset, there is a mean absolute deviation of 3,800 people per square mile between the zip and county population densities.

### Risk Factor Characterization

Each risk factor is chosen for a model based on the unique information the data provides in determining risk. To measure the amount of information provided, the model examines the variance in loss across different values of a risk factor. If the same loss per unit exposure is observed across all values of a risk factor, then that risk factor would not add useful predictive information. Conversely, a larger range of loss per unit exposure across risk factor values would help the model predict the risk in policies. This may be shown by way of examples that have been confirmed by computational analysis.

In one example, a graph was created to display the loss per unit exposure across various ranges of population density per square miles based on zip code. The trend line illustrates a strong linear correlation that the more density populated an area, the higher the loss per unit exposure. More importantly for a predictive model, the variance across values is very large. This variability may explain why population density based on zip code is a top ranked risk factor in the liability model.

In another example, a graph was created to display the loss per unit exposure across various ranges of the number of vehicles on a policy at issue. In comparison to the previous example where loss is correlated to population density, the trend line for number of vehicles shows a flatter linear correlation that the more vehicles on a policy, the higher the loss per unit exposure. Although variance exists across values for this risk factor, they do not vary as widely as those for population density.

In another example, a graph may be created to display the loss per unit exposure across various ranges of the largest claim count over the prior 3 years for a policy. Claim count is one of several prior year risk elements that were evaluated by various models, but were not included in the target model. Similar to number of vehicles in the previous example, the trend line shows a slight linear correlation and small variance across binned values. Although predictive, this was not included in all of the candidate models. In summary, prior term information such as claim count, will be predictive in many different or more complex models, but does not have the predictive information to be a top risk factor in all the models created.

In another example, a graph may be created to display the loss per unit exposure across various ranges of the average number of driver violations on a policy. Average driver violations is one of several MVR (motor vehicle registration) risk elements that were not included in the target model, but will be investigated and added as appropriate in a newer production model. The trend line shows a strong linear correlation that the higher the average driver violations on a policy, the higher the loss per unit exposure. This analysis suggests that adding average driver violations to a future model would help the predictive accuracy.

Losses and premium were used to evaluate the predictive accuracy of the target model. Losses were calculated as paid, plus reserves, developed with a blended IBNR and trended using the Masterson index. The manual premiums used were on-leveled to make predictions and the written premiums used to evaluate the predictions. For each model, liability and physical damage scores were combined to produce one score per vehicle. The vehicle scores were then aggregated to arrive at the total prediction of loss ratio for the policy term. The different graphical representations below illustrate the results of the model predictions broken out into different subsets of data.

For the following graphs, the blind validation policies were ranked based on predictions of expected loss ratio and manual premium. The policies were segmented in to five risk categories through even distribution of trended written premium dollars. Each category was graphed based on the aggregate actual loss ratio (written premium and trended actual loss) for all of the policies in the risk segment. Actual loss ratio numbers were capped at $500K per coverage type, per vehicle.

FIG. 12 displays a measurement of the accuracy of the present model in predicting the risk of archived policies across an entire limousine fleet book of business. A flat line across the 5 risk segments would mean that the model did not discriminate risk. The graph shows a clear differentiation in loss ratio performance between risk segments, with a 45-point spread of actual loss ratio between what the model predicted to be very high risk policies and very low risk policies. The steepness of the line indicates predictive accuracy, because the predicted high risk policies were ultimately unprofitable, and the predicted low risk policies were ultimately profitable.

Due to the magnitude of the loss ratio distinction between high risk and low risk policies, the target model demonstrates predictive accuracy. Deploying this model into the underwriting process would results in better risk selection, hence improving loss ratio performance and bottom-line benefits.

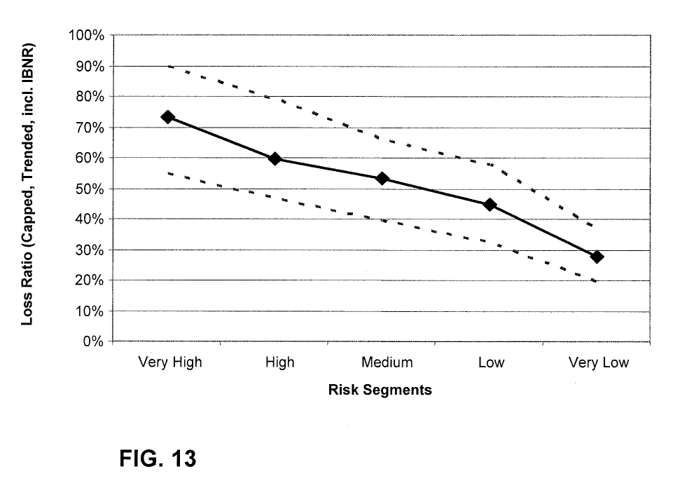

FIG. 13 displays the statistical confidence of the model in production. The dashed lines represent a 90% confidence interval for the actual loss ratios of the risk segments for production (assuming the distribution of data seen in production mimics the distribution of data in the blind validation). This confidence interval was created through the statistical technique of resampling and inverted for predictive use. Resampling involves the creation of new blind validation test sets through repeated independent selection of policy terms. The strength of this technique is that it does not make any distribution assumptions. Note the confidence intervals above exclude the uncertainty of loss development factors used to develop losses to ultimate or the impact of trending on future loss costs.

Production model performance may vary from the results of the blind validation set. Even with 90% confidence, the model is capable of distinguishing between high and low risks. Additionally, the narrowing confidence interval around the lower risk policies indicates strong reliability of these predictions, allowing for more aggressive soft market pricing and actions.

Table IV summarizes the graphical results discussed above. The assessment of model accuracy is an expert modeling opinion based on the slope of the results and the R2, a measure of the proportion of variability explained by the model. An increasingly negative slope (steeper) indicates a larger difference in actual loss ratio performance of the segmented predictions. An R2 closer to 1.00 indicates more consistent model performance.

TABLE IV
Summary of results

| Blind Validation Data Subsets - | | | Model |
|---|---|---|---|
| Capped, Trended, incl. IBNR | Slope | R\hat{ }2 | Accuracy |
| New | −0.1872 | 0.98 | Excellent |
| New - No Experian | −0.1628 | 0.97 | Excellent |
| Small | −0.1268 | 0.97 | Excellent |
| Urban | −0.1130 | 0.96 | Excellent |
| Total Book | −0.1062 | 0.97 | Excellent |
| Sedan | −0.1774 | 0.68 | Good |
| Mixed Fleet | −0.0944 | 0.87 | Good |
| Medium | −0.0901 | 0.92 | Good |
| Owner Operator | −0.0874 | 0.85 | Good |
| Large | −0.0953 | 0.14 | Fair |
| Renewal - No Experian | −0.0670 | 0.77 | Fair |
| Renewal | −0.0503 | 0.74 | Fair |
| Rural | −0.0064 | 0.01 | Poor |

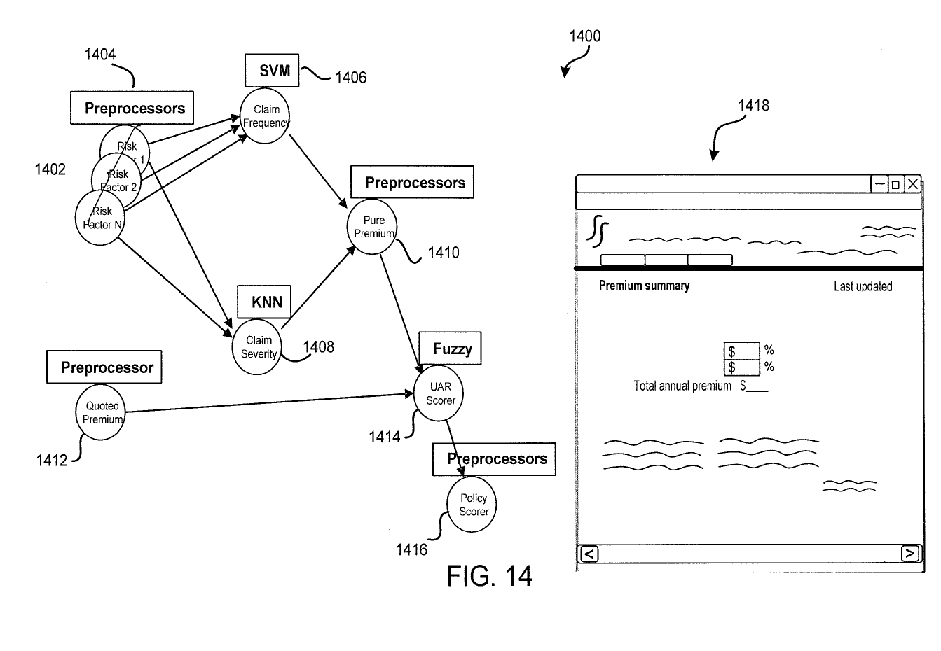

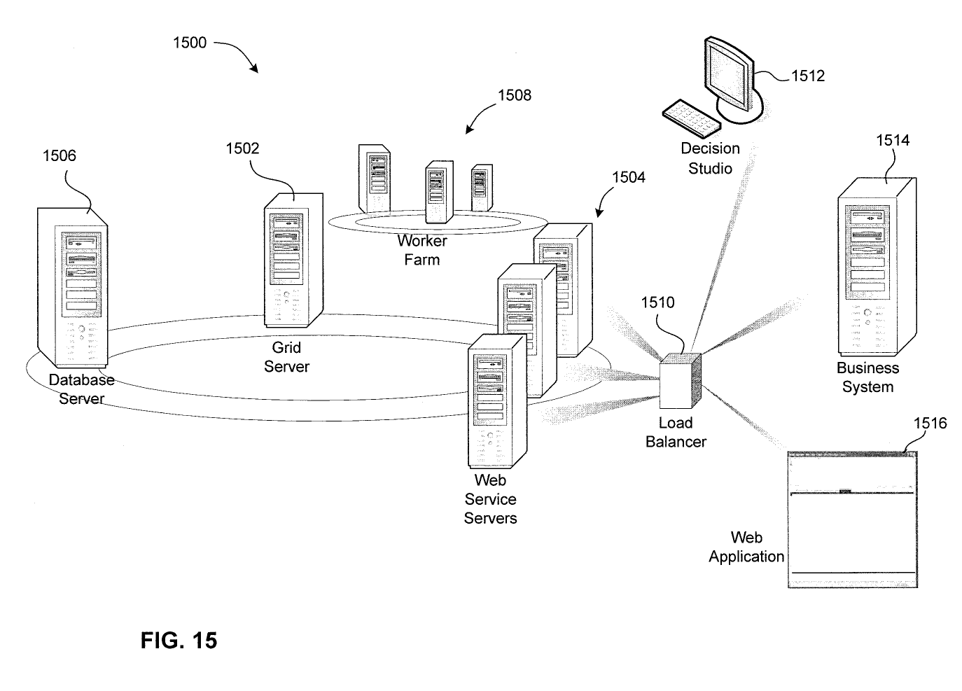

Ensembles that have bee created, tested, and validated as described above may be stored for future use. FIG. 14 shows an ensemble 1400 of this nature as that may be retrieved from storage and used with relationships intact. An agent that is considering candidate policy coverage may accept input values including answers to questions that identify risk factors 1402. Preprocessors 1404 may operate on this data to provide derived data as previously described, for example, with reporting from external data sources (not shown). Risk mapping from the use of prior statistical techniques may be used to assess a likelihood of claim frequency 1406 by the use of SVM technique and claim severity 1408 by the use of KNN technique. Outputs from parts of the ensemble 1400 including claim frequency 1406 and claim severity 1408 pass to assessment of requirements for pure premium 1410, and this assessment may use additional preprocessed data to make this assessment. The agent may enter input including a quoted premium or, more precisely, a premium that might be quoted. A UAR scorer may accept output form the quoted premium 1412 and pure premium 1414 parts of ensemble 1400. The same information may be used by a policy scorer 1416 to assess the overall desirability of writing a policy on the basis of the quoted premium. The calculation results may be presented as a report 1418 that may be used to assess the policy. The relative risk score may be, for example, an overall change of incurring a loss as predicted by an ensemble and scaled to a range of 0 to 100 on the basis of the model output a histogram or frequency distribution of this predictive value.

In operation according to the disclosure above, an insurance company supplies a set of samples, which consist of data for actual policies, e.g., policy data, claims data, billing data, etc. and a set of such risk factors as weight of car, driver's experience, and zip code fin the case of auto insurance. Each sample combines all of the policy information and risk factor data associated with a single policy. A sample set includes samples that are of the same policy type and share the same set of risk factors. The risk factors for a set of samples, typically numbering in the thousands, describe a multi-dimensional space in which each sample occupies one point. Associated with each sample (each point in the hyperspace) is a loss ratio, a measure of insurance risk that is calculated by dividing the total claims against the sample policy by the total premiums collected for it.

The solution provided by the present system is a mathematical decision support model that is based on the sample data. By analogy, what happens is similar to the way which cartographers take a number of data points in three dimensional space and draw a contour map. The sample data is analyzed and multi-dimensional insurance risk maps are generated. Because they are multi-dimensional, however, risk models cannot be presented as simple contour maps; instead, they are described as complex mathematical expressions that correlate insurance risk to thousands of risk factors in multi-dimensional space. The mathematical models produced are, in turn, used by a client application, given data from a policy application, to provide an underwriter with a risk score that predicts the risk represented by that particular policy.

To produce a risk model, a mathematical expression is utilized to characterize the sample data. Each of the thousands of risk factors included in the sample set are variables that could influence the model alone or in interaction with others, making the space of all possible models so vast that it cannot be searched by brute force alone. A key to producing risk models successfully lies in determining which of the risk factors are the most predictive. Typically, only a small fraction of risk factors are predictive. The above procedure uses massive computational power to develop a model around the most representative risk factors. Artificial intelligence techniques and computational learning technology may be used to cycle through different proxy models iteratively, observe the results, learn from those results, and use that learning to decide which model to iterate next. This process occurs hundreds of thousands of times in the process of creating and selecting the most accurate model.

Evaluating hundreds of thousands of candidate models requires a significant amount of computational power. To enable this processing to take place in an acceptable time frame, a parallel processing system on a compute grid was built using Jini technology and the JavaSpace™ API. Using a cluster or grid computer architecture, as descried below, enables the present system in a short time to build risk models that previously took months of labor-intensive work to develop. By building risk models rapidly, such as in a matter of weeks, system users have improved access to up-to-date decision support data that can help retain a competitive edge, avoid adverse selection, and stay aligned with shifting market conditions.

Included in one embodiment of the present system is a conceptual ‘factory’ that generates and tests many model ideas in search of one that will best match a sample data set. A job is defined as one attempt at modeling a given set of samples. A job is composed of multiple iterations. An iteration is a set of tasks. First, an optimizer determines what combinations of task parameters to try and creates an iteration, typically a set of between 2,000 and 20,000 tasks, to run through the compute grid. Those tasks are stored in a database. A master who is responsible for getting those tasks completed, places them into the space and then monitors the space and awaits the return of completed results. Workers take tasks from the space, along with any data needed to compute those tasks, and calculate the results. Since the same task execution code is always used, it is pre-loaded onto all workers.

Tasks may be sized so that it typically takes a worker a few minutes to compute the result. Workers then place the results back into the space as a result entry, which contains a statistics object that shows the fitness of that task's approach. The result entry also contains the entire compute task entry, including a task identifier that allows the master to match the result with its task. To complete the computation of all tasks in an iteration typically takes on the order of hours, and when all task results have been returned to the space the master takes them from the space and stores them in a database. Based on an analysis of results of the completed iteration, the optimizer logic 130 is then able to create a new generation of tasks and initiate a new model iteration. This process continues until a satisfactory model is calculated, typically involving computation of tens of thousands of tasks in total and completing in a few weeks.

In the present compute grid application, each task is a candidate model, and each task is trying to achieve the same goal: prove that it is the best model. The optimizer logic 130 applies different algorithms to the sample data, inspects the results, and creates a new generation of tasks—a new iteration. Through this process, the factory attempts to weed out non-predictive risk factors, to select the best algorithm (or combination of algorithms), and to optimize the performance of the chosen algorithm by tuning its parameters. The process stops once the model has ceased improving for 10 iterations. As a last step, some kerning is performed to make sure the simplest model is chosen of those that are equally good.

The foregoing aspects of this disclosure may be combined as permutations in the process of building a model. By way of example, various aspects include:

Risk Scoring;

Computational Learning;

Grid Computing;

Automation;

Optimization; and

Data preprocessing and validation.

In one embodiment, these may be combined as a computational learning technique for developing risk scores. In another embodiment, these may be combined as using grid computing to develop a risk score. Another combination might include automating the risk scoring process. These may be combined as any combination or permutation, considering that the modeling results may vary as a matter of selected processing sequences.

### Compute Grid Architecture

The following describes how a compute grid architecture may be used to implement a master/worker pattern by performing parallel computation on a compute grid. The architecture, because it is designed to help people build distributed systems that are highly adaptive to change, may simplify and reduce the costs of building and running a compute grid. This is a powerful yet simple way to coordinate parallel processing jobs.

The architecture facilitates the creation of distributed systems that are highly adaptive to change, and is well suited for use as the underlying architecture of compute grid applications. The architecture enables compute grid masters and workers to find and connect to host services and each other in dynamic operating environments. This simplifies the runtime scaling and failure recovery of compute grid applications. Extending the Java platform programming model to recognize and accommodate partial failure, the architecture enables the creation of compute grid applications that remain highly available, even if some of the grid's component parts are not available. Robustness is further enhanced with support for distributed systems security. And finally, a Java-based service contributes a simple yet powerful coordination point that facilitates task distribution, load balancing, scaling, and failure recovery of compute grid applications.

The grid architecture of system 1500 may be The architecture approach to parallel computation involves three kinds of participants: (1) masters, (2) JavaSpace™, and (3) workers. In its most basic form, the architecture permits a master to decompose a job into discrete tasks. Each task represents one unit of work that may be performed in parallel with other units of work. Tasks may, for example, be associated with objects written in the Java™ programming language (‘Java objects’) that can encapsulate both data and executable code required to complete the task. The master writes the tasks into a space, and asks to be notified when the task results are ready. Workers query the space to locate tasks that need to be worked on. Each worker takes one task at a time from the space and performs the tasked computation. When a worker completes a task, he or she writes a result back into the space and attempts to take another task. The master takes the results from the space and reassembles them, as needed to complete the job.

As shown in FIG. 15, a grid architecture system 1500 includes a grid server 1502 that controls operations on a plurality of web service servers 1504. The grid server 1502 and the web service servers 1504 may report from a database server 1506. A worker farm 1508 may be networked to the grid server, either using a LAN or WAN, or through the web service servers 1504. A load balancer monitors the relative activity levels of each of the plurality of web servers 1504 and adjust the relative loads to balance the activity of these servers. The web servers 1504 through the load balancer 1510 support a number of end user applications including a decision studio 1512 where decisions are made about the overall terms and conditions of various policies that will be underwritten for particular insurance types, insurer business systems 1514 which for budgetary reasons may need to track financial projections and issued policies, and web applications 1516 through which agents may interact with the system 1500.

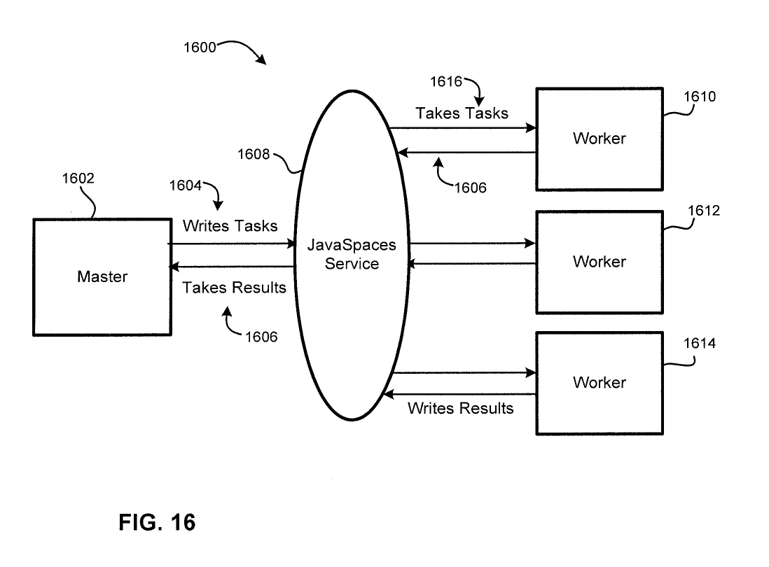

The grid architecture of system 1500 may be operated according to workflow process 1600, as shown in FIG. 16. A master 1602 writes tasks 1604 and takers results 1606. The tasks are disseminated into a JavaSpace™ 1608 where they are stored and presented for future work. A number of workers 1610, 1612, 1614 take on these tasks, each taking a task 1616 and writing a result 1618 back. The written results 1618 are transferred to the JavaSpace™ 1608 and transferred to the master 1602 as a taken result 1606. This basic methodology may be implemented on a grid that uses system, such as system 1500, where for example, there is distributed databasing and reporting capability. The JavaSpace™ 1608 may be implemented on any network including a LAN, WAN, or the Internet.

One fundamental challenge of using system 1500 is simply coordinating all the activities of such a system. Beyond the coordination challenges presented by a single job are the challenges of running multiple jobs. To obtain maximum use of the compute resources, worker idle time should be minimized. If multiple jobs can be run in parallel, the tasks from one job may be kept separate from the tasks of other jobs.

The centerpiece of this compute grid architecture is the JavaSpace™ 1408, which acts as a switchboard through which all of the grid's distributed processing is coordinated. The ‘space’ is the primary communication channel between masters and workers. The master sends tasks to the workers, and the workers send results back to the master, all through the space. More generally, the space is also capable of providing distributed shared memory capabilities to all participants in the compute grid. Entries may be used to maintain information about the state of the system, information that masters and workers can access to coordinate a wide range of complex interactions. Simplicity is what makes the power of this architecture most appealing: four basic methods (read, take, write, and notify) provide developers with all the capabilities necessary to coordinate distributed processing across a compute grid.

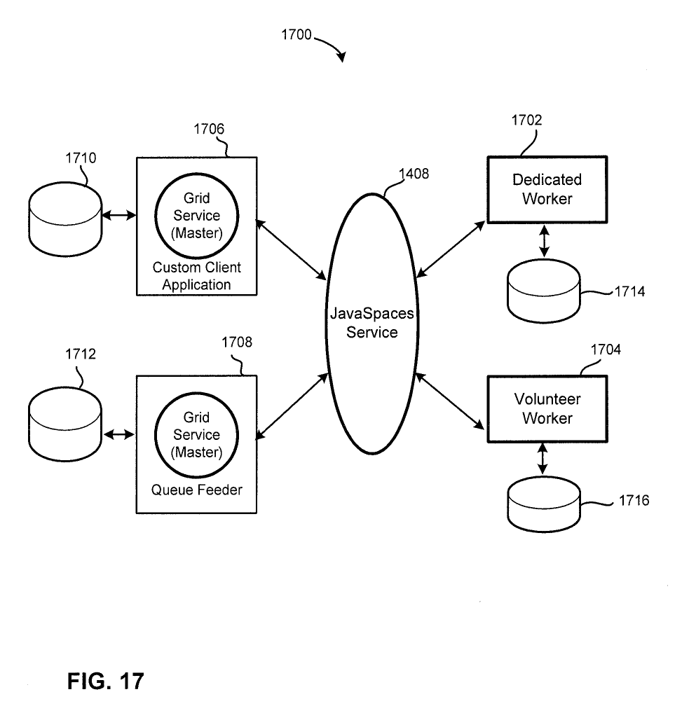

The question of how to assign tasks to workers is easily resolved by use of an interaction paradigm 1700, as shown in FIG. 17. Workers may be dedicated workers, which are assigned to a particular job. Volunteer workers 1704 may be assigned or choose to participate to work on tasks for various jobs and are not assigned to any one particular job or client. A plurality of masters 1706, 1708 may divide the tasks that are performed by masters. As shown in FIG. 17, grid service master 1706 identifies tasks that are need to develop and maintain a custom client application, which entails the creation of a model, use of that model, and maintenance of that model by processes as described above. Grid master 1706 writes these tasks to JavaSpace™ 1408. Grid master 1708 is involved in breaking down these tasks into components and tracking the workflow to assure timely completion as a scheduler. Grid master 1708 operates upon larger tasks requested by the grid master 1706, breaks these down into assignable components, and tracks the work through to completion. Data storage 1710, 1712, 1714, 1716 represents distributed databases that are maintained proximate their corresponding users by the action of database server 1506 (see FIG. 15).

The workers 1702, 1704 access the JavaSpace™ 1408 to look for task entries which may be provided in template form for particular task requests. The template entries may have some or all of their fields set to specified values that must be matched exactly. Remaining fields are left as wildcards—they are not used in the task request lookup. Each worker looks for and takes entries from the space that match the task template that it is capable of executing. In the most flexible model, generic workers each match on a template that features an “execute” method, take a matching entry, then simply call the execute method on the taken task to perform the work required. In this worker pull model, tasks need not be assigned to workers from any centralized coordination point; rather, the workers themselves, subject to their availability and capabilities, determine which tasks they will work on and when.

The JavaSpace™ 1408 may have a notify feature that is used by masters to help them track the return of results associated with tasks that they put into the system. The master provides a template that can be used to identify results of the tasks that it put into the space, then registers with the JavaSpace™ service to be notified when a matching result entry is written into the space. To distinguish between tasks, implementations of the basic compute grid architecture generally place a unique identifier into each task and result entry they write to the space. This enables a master to match each result to the task that produced it. Most implementations further partition the unique identifier into a job ID and a task ID. This makes it easy for workers and masters to distinguish between tasks and results associated with different jobs, and hence serves as a simple technique for allowing multiple jobs to run on the compute grid at the same time.

The optimal way to manage work through a compute grid often depends on the sort of work that is being processed. For example, some computations may require that a particular task be performed before others. To keep the system busy, jobs may be queued up in advance so they run as soon as computation resources become available.

The most flexible compute grids are able to run different computations on different nodes at the same time, and to run different computations on a single node over time. To allow this flexibility, a compute grid may employ generic workers that can be equipped dynamically to handle whatever work needs to be processed at any given time.

Using a JavaSpace™ service-based grid model, as described above, this is accomplished fairly simply. Because JavaSpace™ task entries represent Java objects, entries offer a natural medium for delivering both the code and data required to perform a task. In one example, a serialized form of task entries may be annotated with a codebase URL. Leveraging this capability, a master places both the data and an associated codebase annotation into a task entry which it writes to the space. When a worker takes a task from the space, it deserializes the task and dynamically downloads the code needed to perform the task work.

For an insurance company, often a mere 8% of policies generate 80% to 90% of claims filed. Thus, companies that act to improve their risk prediction capabilities, based on the data supplied on the policy application process can improve their profitability, lower their overall risk, be more competitive, and charge their customers prices for insurance that are commensurate with the actual risk.

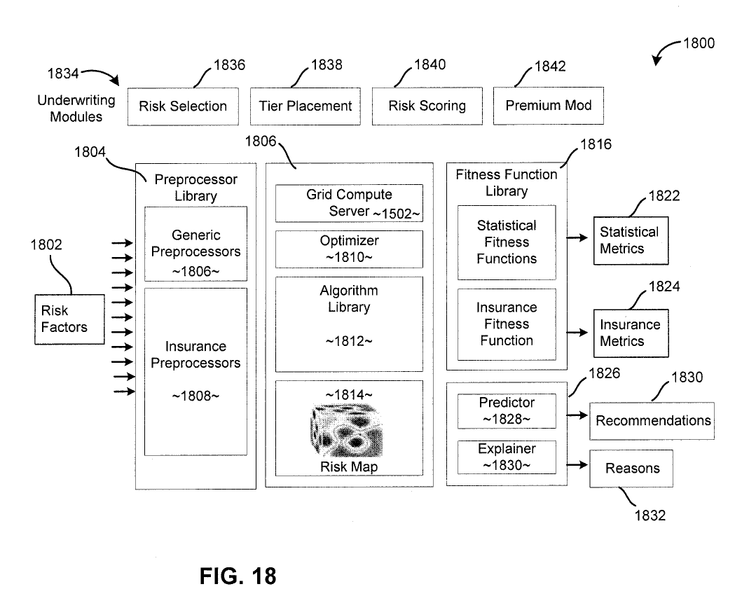

FIG. 18 shows various logical elements of an automated predictive system 1800 that may use a model which has been developed as described above. The system operates on risk factors 1802 that may be obtained by questioning a candidate for new insurance or insurance renewal. The risk factors 1802 are input to a translator/preprocessor library 1804 that may contain generic preprocessors 1806 and insurance preprocessors 1808. The generic preprocessors 1806 constitute algorithms for the creation of derived data from external sources and translation of the risk factors 1802. This may be done in the same manner as previously described for the use of external data 114 in the production of derived data by preprocessors 118. Insurance preprocessors 1808 may include proprietary algorithms belonging to a particular insurance company that are used to process the risk factors, such as a system of expert rules.

Modeling logic 1806 uses the grid compute server 1502, as previously described, to perform calculations. An optimizer generates a number of policy terms and conditions for use in studying the risk factors according to a particular model. An algorithm library may be accessed to retrieve algorithms that are used in executing ensembles, as previously discussed. A risk map 1814 may be provided as one or more ensembles that have been previously created by use of the foregoing modeling process. The risk map 1814 may combine risk factor data with algorithms from the algorithm library 1812 to form executable object, and execute these objects to yield calculation results for any parameter under study.

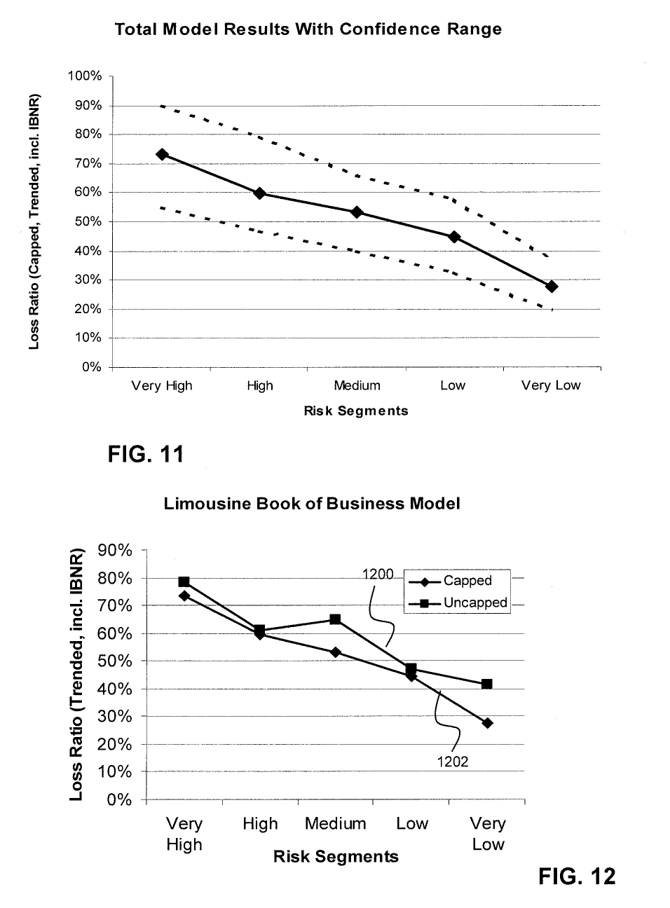

An evaluator 1816 includes a fitness function library including statistical fitness functions 1818 and insurance fitness functions 1820. The statistical fitness functions yield results including statistical metrics 1822 and insurance metrics 1824. The statistical metrics 1822 may include, for example, a confidence interval as shown in FIG. 11 or a histogram as shown in FIG. 2. The insurance metrics may yield, for example, risk scoring values as shown in FIG. 14. Interpreter logic 1826 may evaluate or score the statistical metrics 1822 and insurance metrics 1826 using predictor logic 1828 and explainer logic 1810. The predictor logic 1828 may provide recommendations 1830 including policy options that benefit the company that is writing the policy, as well as the candidate for insurance. The explainer logic 1810 provides reasons 1832 why coverage may be denied or the premiums are either low or high compared to median values. Users are provided with various modules that are functionally oriented. A risk selection module 1836 may be used to screen new accounts and renewal business. In one example of this, based upon the responses that a candidate for insurance may provide, an appropriate model may be provided according to a particular segmentation strategy, as discussed above in context of screen filter 123.

Tier placement 1838 is used to identify the type of insurance, such as worker's compensation, commercial automobile, general liability, etc. Risk scoring may be used to evaluate the suitability of a candidate for insurance in context of policy terms and conditions. Premium modification logic 1842 may be linked to business information that tracks the financial performance of policies in effect, as well as changes in risk factors over time. The premium modification logic may recommend a premium modification on the basis of current changes to data indicating a desirability of adjusting premium amounts up or down.

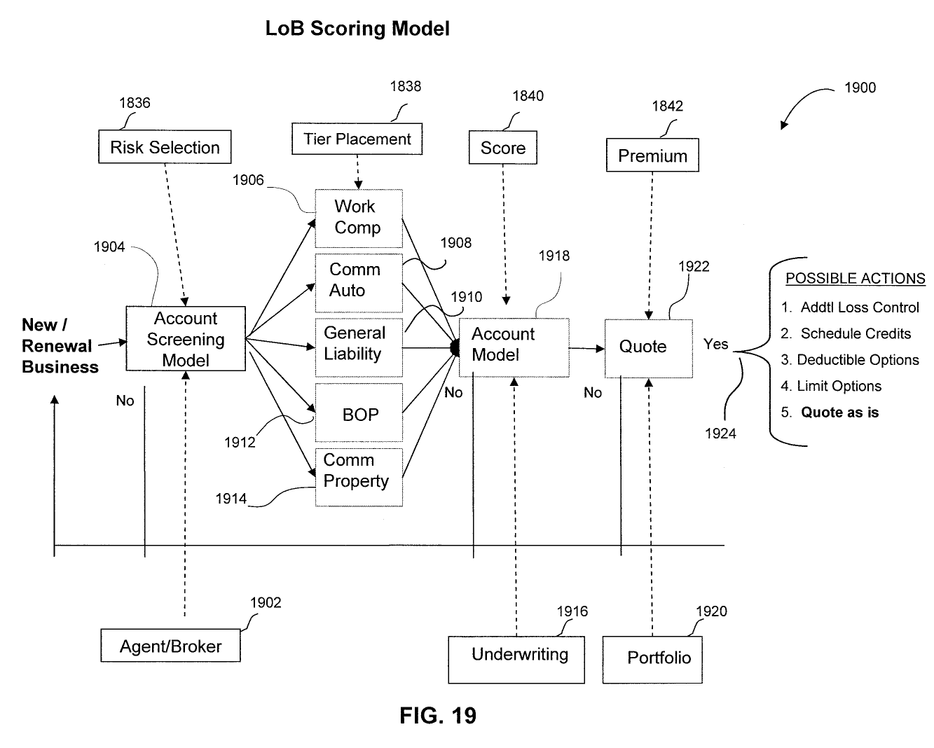

Various models, as described above, may be combined for different insurance types to service a particular account. FIG. 19 shows one type of account structure 1900 that may be used for all insurance offerings by a particular company. An agent/worker may use account screening logic 1904 to screen a candidate for new business or renewal business. If this screening indicates that the candidate is suitably insurable, tier placement logic 1838 ascertains whether the request for insurance should be allocated to a particular type of insurance that is offered by this carrier, such as worker's compensation 1906, commercial automobile 1908, general liability 1910, BOP 1912, or commercial property 1914. An underwriter 1916 may then use risk scoring logic 1840 to analyze the risk by use of an account model 1918, which may be the risk map 1814 as described in FIG. 18. If the risk scoring shows that the candidate is suitable for insurance, a portfolio manager 1920 may use premium modification logic 1842 to provide a quote analysis 1922. The quote analysis may contain recommendations for possible actions 1924 including loss controls defined as the scope of coverage, credits, deductible option, loss limit options, or to quote the policy without changing these options.

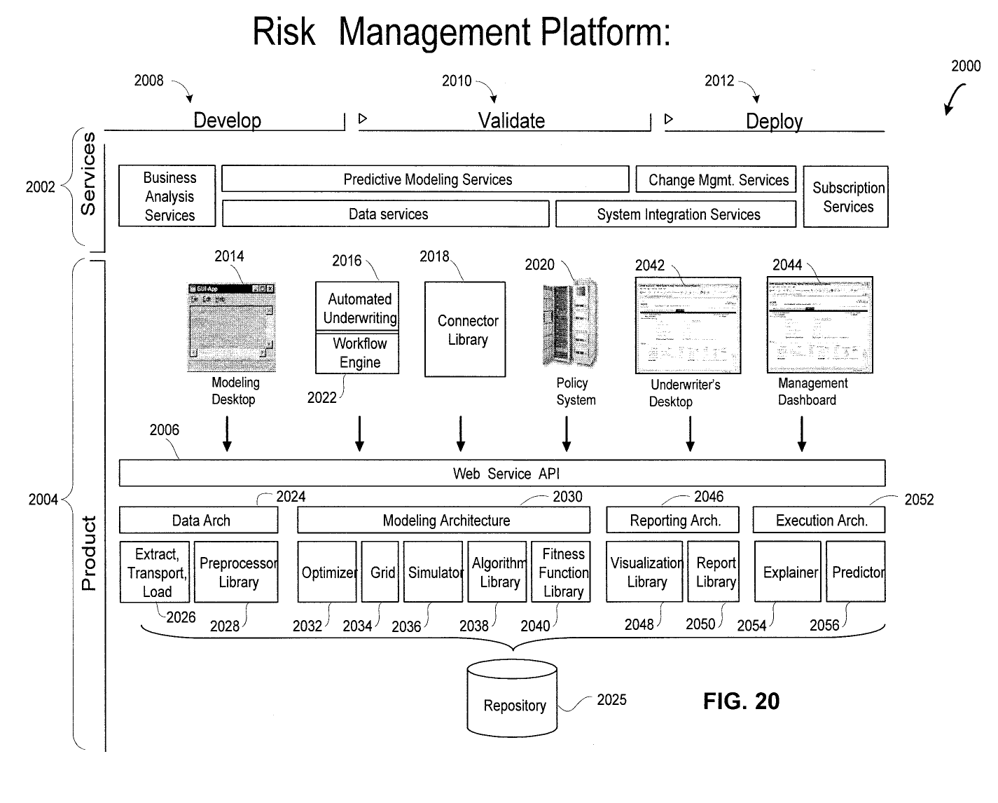

FIG. 20 shows a platform or system 2000 that may be combined for model creation and account servicing. The system 2000 provides services 2002 through the use of software and hardware products 2004. The services are generally provided through a web service API 2006. as illustrated, the services 2002 and products 2004 may be used for sequential purposes that proceed through development 2008, validation 2010, and deployment 2012. A modeling desktop 2014 is a user interface that facilitates model development, for example, according to processes shown in FIG. 1. This type of desktop may be used by the respective masters and workers of FIG. 17.

The processes of development 2008 and 2010 are supported by automated underwriting analysis 2016, an algorithm library 2018 that may be used in various ensembles as shown in FIG. 4, and a policy system for use in generating policies as shown in FIG. 9. A workflow engine 2022 facilitates the creation, assignment and tracking of discrete tasks. These systems are operably configured to access, as needed, a repository 2025. The repository 2025 includes a data archive 2024 including algorithms 2026 for the extraction, transfer, and loading of data, and a preprocessor library 2028. The repository 2030 includes a modeling architecture 2030, which may include software for the optimizer 2032 in developing a model as may be implemented on a grid architecture 2034. The modeling architecture may include a simulator 2036 for the use of a developed model. The modeling architecture may be supported by access to an algorithm library 2038 and a fitness function library 2040.

Contents of the algorithm library 2038 and the fitness function library include, generally, any algorithm or fitness function that may be useful in the performance of system functionality. Although not previously used for the purposes described herein, such algorithms are generally known to the art and may be purchased on commercial order. Commercially available packages or languages known to the art include, for example, Mathematica™ 4 from Wolfram Research; packages from SalSat Statistics including R™, Matlab™, Macanova™, Xli-sp-stat™, Vista™ PSPP™, Guppi™, Xldlas™, StatistX™, SPSS™, Statview™, S-plus™, SAS™, Mplus™, HLM™, LogXact™, LatentGold™, and MlwiN™.

Deployment occurs through interfaces including an underwriter's desktop 2042 that provides a reporting capability for use by underwriters. A management dashboard 2044 may be used by a portfolio manager to provide predictions and explain results. The underwriter's desktop is supported by reporting architecture 2046 that may access predetermined reporting systems to provide a visualization library 2048 of graphical reports and as report library of written reports. These reports may be any report that is useful to an insurer or underwriter. The management dashboard 2044 is supported by an execution architecture 2052 including explainer logic 2054 and predictor logic 2056 that are used to provide reports predicting policy outcomes and explaining the influence of risk factors upon the modeling results.

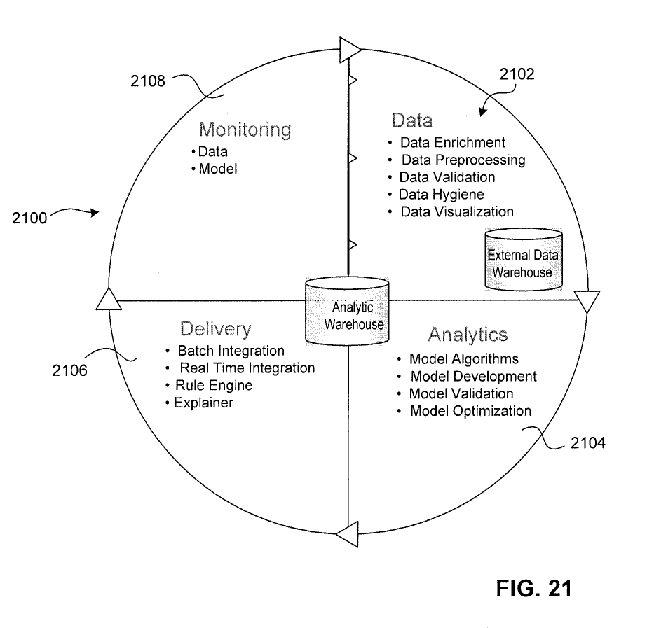

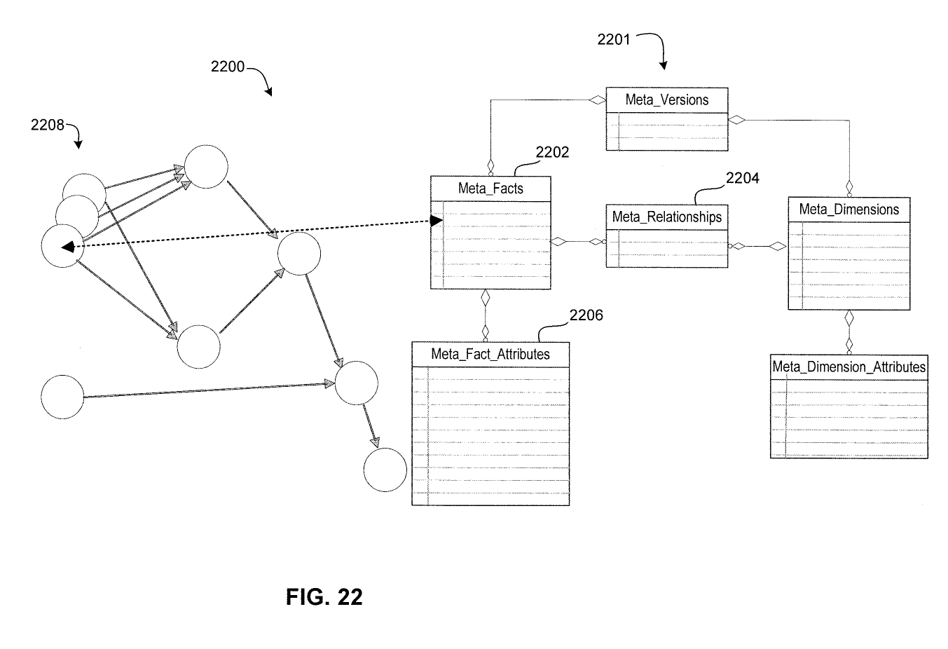

As shown in FIG. 21, various aspects of the foregoing instrumentalities may be combined and rearranged into an underwriting package 2100. Data algorithms 2102 may be provided generally to accomplish the dataset preparation functionality that is described in context of dataset preparation 102 (see FIG. 1). It will be appreciated that in addition to dataset preparation 102, it is possible to enrich data for use in the modeling process by reporting that permits such data to be used by an ensemble. Accordingly, the data algorithms 2102 may include data enrichment preprocessor 2200 as shown in FIG. 22. An extended data warehouse 2201 may contain external data 114 (not shown) together with various rules and relationships for the preprocessing of external data. The extended data warehouse 2201 may be structured as a relational database that includes various linked tables, such as tables 2202, 2204, 2206. Node 2208 of ensemble 2210 may report from these tables to retrieve data or facts, and to identify algorithmic relationships for retrieval. The algorithmic relationships may be used to preprocess the data or facts according to the reporting protocol of ensemble 2210. It will be further appreciated that sources of external data may be continuously updated, so this preprocessing based upon a call from the ensemble to perform data enrichment and preprocessing is one way to update the predictive accuracy of the model as time progresses after model development.

Data validation and data hygiene algorithms are used to assure that incoming data meets expected parameters. For example, a numeric field may be validated by scanning to ascertain alphanumeric parameters. A numeric field may be scanned to assure that a reported value is suitably within an appropriate range of expectation. Values that fall outside of a predetermined confidence interval may be flagged for substitution. If the incoming data is blank or null, preprocessing algorithms may be used to derive an approximation or estimate on the basis of other data sources. If a statistical distribution of the incoming data fails to meet predetermined or expected parameters, the entire field of data may be flagged and a warning message issued that that the data is suspect and requires manual intervention to approve the data before it is used. This last function is useful to ascertain, for example, if a technician has uploaded the wrong data into a particular field, as sometimes may happen. Data fields or relationships between data fields may be selectively reported as tables or graphs for visual review.

Analytical logic 2104 may be implemented as previously discussed in context of model development 104 and model validation 106 of FIG. 1. The resulting model is made available as an implemented model for a particular account.

Delivery logic 2106 may be implemented using the grid architecture system 1500 to provide the automated predictive system 1800 that is described above. Work by the system 2100 may be performed on a batch or real time basis. A rule engine may provide a system of expert rules for recommending policy options or actions, for example, to a new candidate for insurance or at the time of policy renewal. Explainer logic may provide an explanation of reasons why premiums are especially high or especially low. The delivery logic of system 2100 provides reports to facilitate these functionalities, for example, as images that are displayed on a computer screen or printed reports. Users may interact with the system by changing input values, such as policy options to provide comparative reports for the various options, and by selecting for use of different sets of rules that have been developed by experts who differ in their experience and training. In one example, life insurance options and recommendations may be facilitated by an expert that is designed to optimize income under the policy, or by an expert that is designed to provide a predetermined amount of insurance coverage over a specified interval at the least amount of cost.

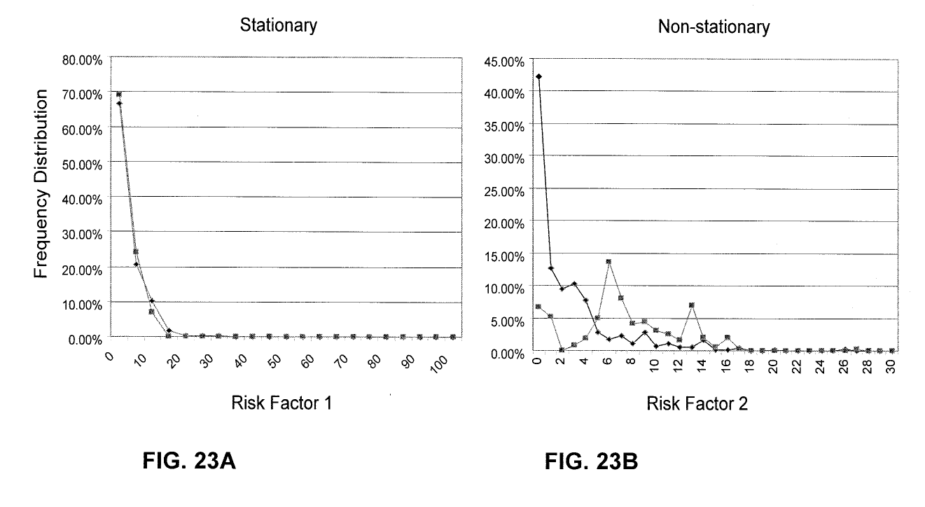

In addition to the previously described system functionalities, is it useful to provide monitoring logic 2108 to continuously assess incoming data and the predictive accuracy of the model. FIGS. 23A and 23B show a comparison between stationary (FIG. 23A for Risk Factor 1) and non-stationary (FIG. 23B for Risk Factor 2) risk factors. FIGS. 23A and 23B each represent the results of frequency distribution calculations for a particular risk factor that is scaled to a range of 0 to 100 on the X-axis. Circles identify calculation results for data that was used to develop the model, while squares identify calculation results for data that has arrived after the model was implemented. As can be seen from FIG. 23A, there is no meaningful change in the nature of the incoming data, and so the predictive value on the implemented model should continue to be quite high on the basis of incoming data for Risk Factor 1. On the other hand, FIG. 23B shows a significant change in the incoming data for Risk Factor 2 where the respective lines identified by the circles and squares are not closely correlated. This may be due to a number of circumstances, such as a change in demographics, the data becoming distorted due to a change in the way insurance agents are selecting people or companies to insure, a change in the way the data is being reported by the official source of the data, or a clerical error in entering or uploading the data. The monitoring logic may identify these changes by correlation analysis to compare the respective curves and print out reports for potential problem areas. If an investigation confirms that the required data truly has changed, this may reflect a need to access analytical logic 2104 for purposes of updating or tuning the model to assure continuing predictive accuracy of the implemented model.

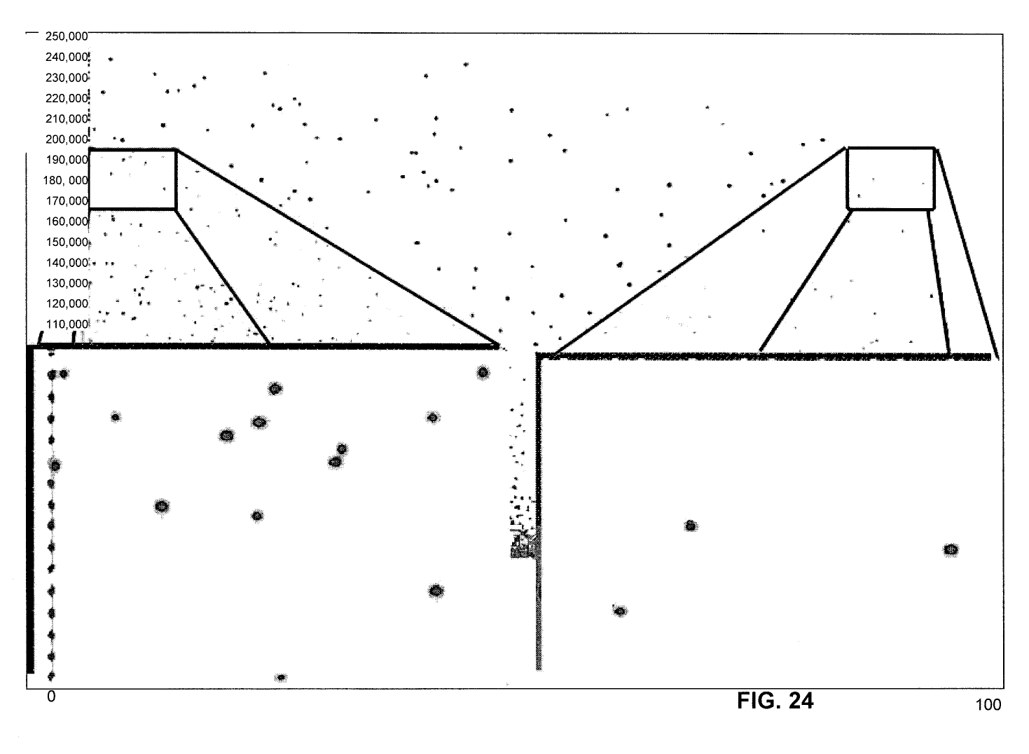

FIG. 24 shows an additional way to evaluate the implemented model. A scatterplot of data may be made as a relative risk factor on the X-axis and actual policy losses on the Y-axis. The relative risk factor may be calculated on a decile basis as described with respect to deciles 904 of FIG. 9, or on the basis of a policy scorer 1416 as previously described. Basically, the relative risk factor represents a score or value that adjusts the number of policies actually written to a substantially uniform density when plotted with respect to the X-axis. The outcome that is being monitored, in this case losses, may be similarly scaled into deciles.

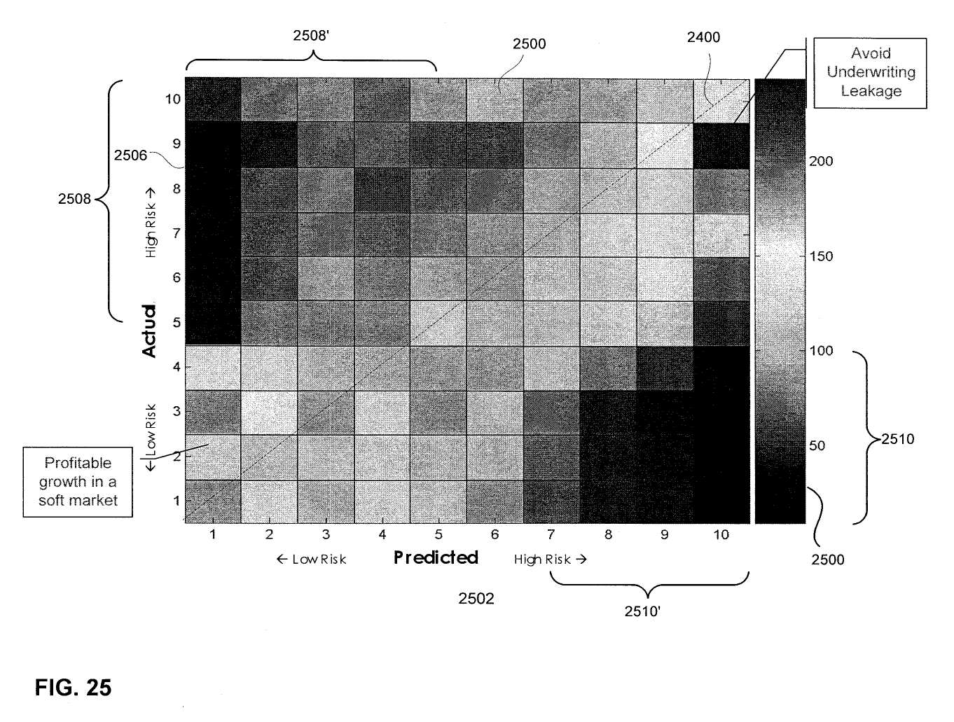

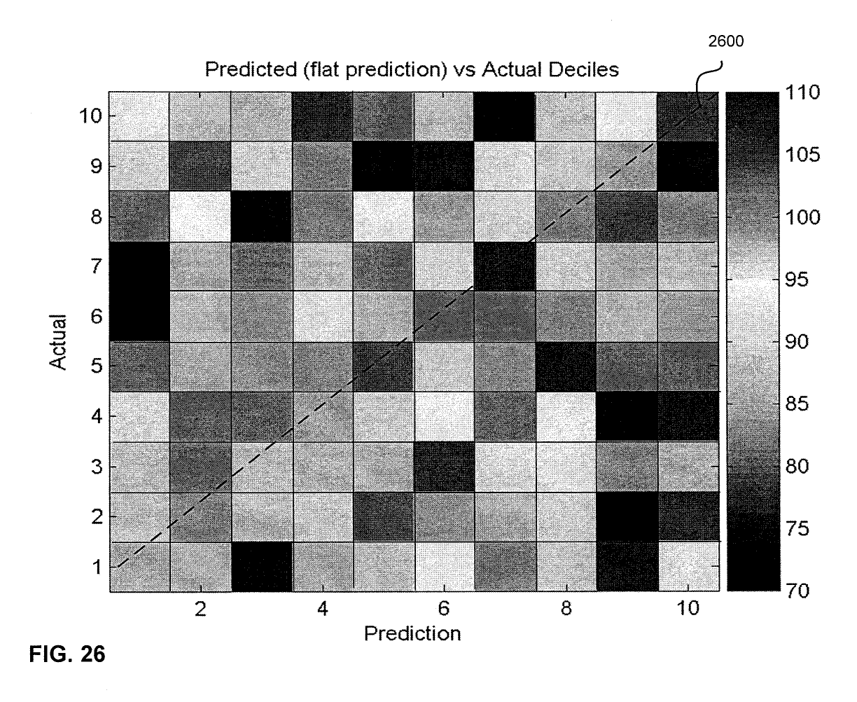

FIG. 25 shows shaded squares, such as square 2500 representing the intersection of decile 6 (X) and decile 10(Y). The shading of the squares (color may also be used pursuant to scale 2502) is correlated to the density of points that fall in these areas on the basis of the scatterplot that is shown in FIG. 24. The substantially uniform shading generally along line 2504 at the midrange of scale 2502 in this case is interpreted to show that the implemented model has good predictive value as represented by actual losses. A dark area 2506, as well as a larger darkened area 2508, 2508′ corresponding to a low density of points on scale 2502 confirms that the pricing terms of this policy may be adjusted to achieve profitable growth of the number of newly issued or renewed policies in a soft market for this type of insurance. The area 2510, 2510′ confirms another low density of hits to confirm that the pricing terms of this policy may be adjusted to reduce a phenomenon that is known as underwriting leakage, as explained in more detail below. FIG. 26 shows a model that has poor predictive value, as indicated by the lack of shading uniformity along line 2600.

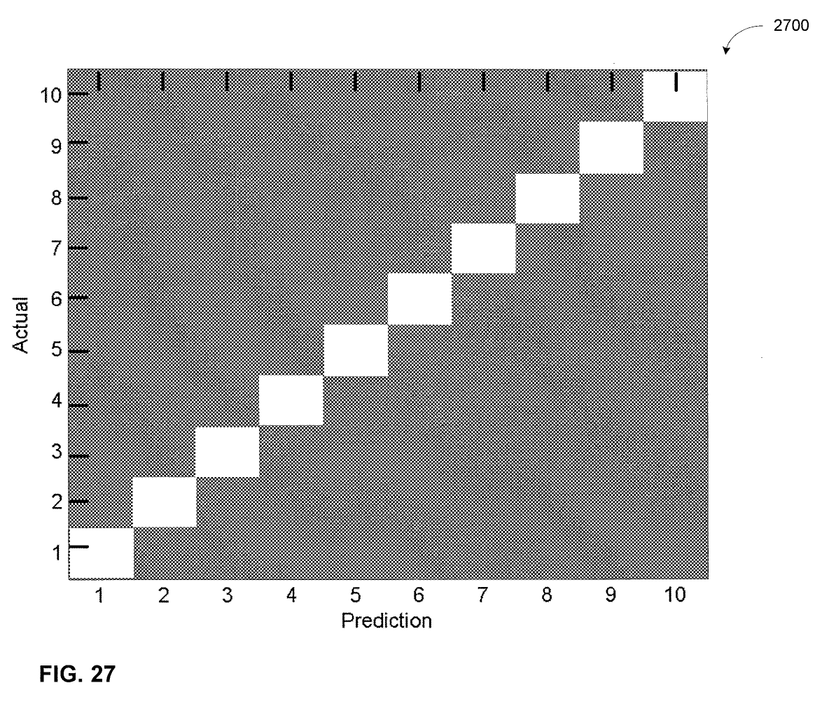

FIG. 27 shows the theoretical appearance of a truly clairvoyant model that is one-hundred percent predicatively accurate. The distribution of data all fall within the deciles located on a 45° range of shaded deciles, with no hits in other deciles. Real world data seldom if ever performs in this manner, so FIGS. 25 and 26 provide interpretable results of the predictive model accuracy.

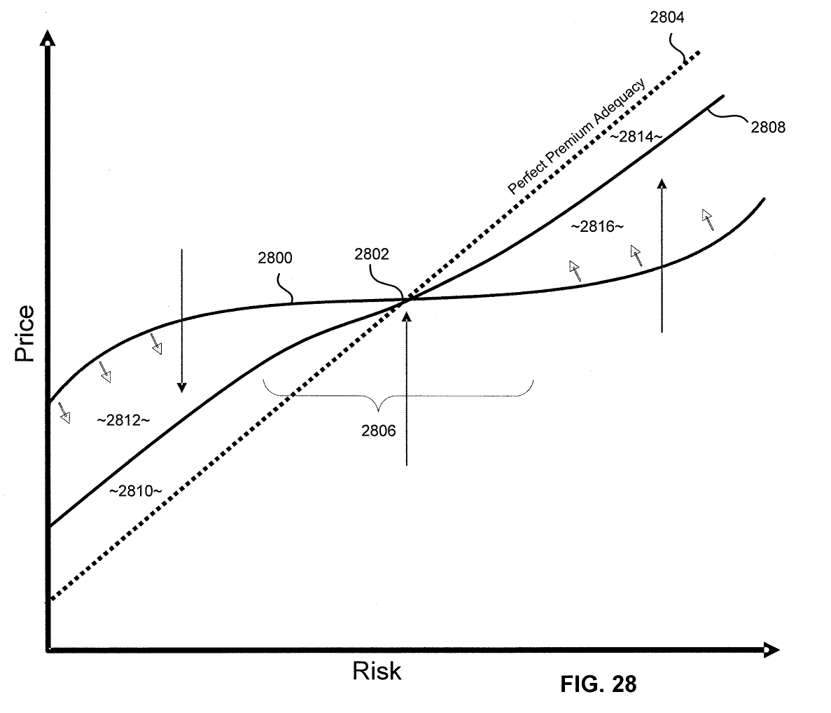

FIG. 28 illustrates generally the price risk relationship 2800 that results from conventional modeling practices in the insurance industry. Because these conventional models are perceived as requiring explainability and they are based upon the analysis of too few risk factors, the price-risk relationship is often keyed to a midrange pricing point 2802. It is problematic that these conventional practices are unable to arrive at a more perfect representation of premium adequacy, such as line 2804, where there is a more directly ascertainable relationship between risk and price. Generally, this goal is defeated by the flat midrange plateau 2806 that arises from traditional modeling practices due to their lack of complexity and sophistication. Line 2808 represents an improvement that may be brought about by the presently disclosed system relative to the traditional relationship 2800. Area 2810 beneath line 2808 represents a reduction of area 2812 bringing line 2808 closer to the ideal of line 2804. This reduction of area shown as area 2810 compared to area 2812 permits an insurer to issue policies with higher predictive value such that the number of issued policies may grow profitably in a soft market for insurance. In like manner, the reduction of area shown as area 2814 compared to area 2816 show that the improved predictive value of line 2808 reduces underwriting leakage.

Generally, the underwriting leakage phenomenon indicated by area 2816 occurs due to the relatively poor predictive value of prior art models. The area 2816 represents a loss for high risk insurance that must be offset by the profits of area 2812. Thus, the premium pricing places an undue burden upon low risk insureds who fall in area 2812. Accordingly, the higher predictive value of the presently disclosed system permits underwriters to adopt an improved pricing strategy that substantially resolves this inequity.

The foregoing discussion teaches by way of example and not by limitation. Accordingly, insubstantial changes from what is shown and described fall within the scope and spirit of the invention that is claimed.

What is claimed is:

1. A computerized modeling system that operates on an initial data collection which includes risk factors and outcomes, comprising:
data storage for a plurality of risk factors and outcomes that are associated with the risk factors;
a library of algorithms operable to test variable interactions between the risk factors and results to confirm statistical validity of the associations;
optimization logic that forms an ensemble as a combination of the algorithms operating on model components selected from the group consisting of data, fitness functions, relationships, predefined rules and combinations thereof, and relates the respective parts of the ensemble to establish data flow as needed between the respective parts of the ensemble;
the optimization logic iterating to modify the ensemble by selecting alternative parts to form a plurality of such ensembles, test the ensembles for fitness, and select the best ensemble for use as a production model; and
means for interacting with the production risk model to perform business operations using the production risk model as a predictive tool.

2. The system of claim 1, further comprising means for deploying the risk model on a production basis to underwrite insurance policies.

3. The system of claim 1, wherein the predefined rules implement a pattern of temporal boost by competitively evaluating long term, medium term, and short term sample sets.

4. The system of claim 1, wherein the predefined rules implement a sequencer that provides a temporal abstract to shift a variable over time.

5. The system of claim 1, wherein the predefined rules implement an automated data enrichment preprocessor that performs external data including at least one data type selected external data at least selected from the group consisting of firmagraphic, demographic, econometric, geographic, weather, legal, vehicle, industry, driver, property, and geo-location data

6. The system of claim 1, further comprising means for blind validation to confirm the risk model that is produced by the optimization logic.

7. The system of claim 1 implemented on a grid architecture that permits at least one master to assign discrete tasks to a plurality of workers.

8. The system of claim 7, further comprising a web-services interface to end users of the risk model.

9. The system of claim 1, wherein the risk model provides risk scoring for insurance underwriting purposes.

10. The system of claim 1, wherein the risk model provides risk selection for insurance underwriting and actuarial purposes.

11. The system of claim 1, wherein the optimization logic iterates in stages that include:
(a) creating a candidate model;
(b) evaluating the model with respect to model fitness;
(c) re-evaluating the model with respect to model fitness; and
(d) repeating steps (a) through (c) using a new set of model parameter permutations until an optimal model is found.

12. The system of claim 1, further comprising means for monitoring new data that is used for predictive purposes by comparison to statistical parameters of data upon which the predictive model is based.

13. The system of claim 1, further comprising means for enriching data that is used in the risk model by reporting from a plurality of data sources and preprocessing the data to provide values that are useful to the model.

14. The system of claim 1, further comprising screening filter logic for reporting from the data storage on the basis of one or more selection parameters to identify a subset of risk factors and outcomes for submission to the library of algorithms and the optimization logic.

15. The system of claim 14, wherein the screening filter logic is automated to provide screening by the use of a rule.

16. The system of claim 14, wherein the screening filter logic operates on a plurality of selection parameters.

17. A method of modeling operates on an initial data collection which includes risk factors and outcomes, comprising:
on a computer system
storing data for a plurality of risk factors and outcomes that are associated with the risk factors;
accessing a library of algorithms that operate to test associations between the risk factors and results to confirm statistical validity of the associations;
creating an ensemble for optimization by receiving groups of risk factors, selecting predetermined design patterns for calculations at respective ensemble parts according to a set of predefined rules, and relating the respective parts of the ensemble to establish required data flow between the respective components;
tuning the ensemble by iterations of the step of creating to form a plurality of new ensembles, testing the ensembles for fitness, and selecting the best ensemble for use in a risk model.

18. The method of claim 17, further comprising a step of deploying the risk model on a production basis to underwrite insurance policies.

19. The method of claim 17, wherein the predefined rules implement a pattern of temporal boost by competitively evaluating long term, medium term, and short term business goals.

20. The method of claim 17, wherein the predefined rules used in the step of creating an ensemble implement a sequencer pattern by comparing the predictive accuracy of risk factor data that is accumulated for analysis over a period of time.
